(19) United States
(12) Patent Application Publication
(10) Pub. No.: US 2025/0246760 A1
(43) Pub. Date: Jul. 31, 2025

(54) COATED MICROPOROUS MEMBRANES, AND BATTERY SEPARATORS, BATTERIES, VEHICLES, AND DEVICES COMPRISING THE SAME

(71) Applicant: CELGARD, LLC, Charlotte, NC (US)

(72) Inventors: Insik Jeon, Ithaca, NY (US); James Rapley, Concord, NC (US); Xiang Yu, Indian Land, SC (US); Fru Azeh, Charlotte, NC (US); Stefan Reinartz, Waxhaw, NC (US); Zhengming Zhang, Rock Hill, SC (US)

(21) Appl. No.: 19/084,202

(22) Filed: Mar. 19, 2025

Related U.S. Application Data
(62) Division of application No. 17/419,324, filed on Jun. 29, 2021, now abandoned.
(60) Provisional application No. 62/788,200, filed on Jan. 4, 2019.

(51) Int. Cl. H01M 50/489; H01M 10/0525; H01M 50/426; H01M 50/434; H01M 50/443; H01M 50/446; H01M 50/449; H01M 50/451; H01M 50/457; H01M 50/491

(52) U.S. Cl. CPC H01M 50/489; H01M 10/0525; H01M 50/426; H01M 50/434; H01M 50/443; H01M 50/446; H01M 50/449; H01M 50/451; H01M 50/457; H01M 50/491

(57) ABSTRACT

Disclosed herein are battery separators that include a microporous membrane and a coating. The coating may comprise, consist, or consist essentially of polymeric components, inorganic components, or combinations thereof. The battery separators described herein are, among other things, thinner, stronger, and more wettable with electrolyte than some prior battery separators. The battery separators may be used in secondary or rechargeable batteries, including lithium ion batteries. The batteries may be used in vehicles or devices such as cell phones, tablets, laptops, and e-vehicles.

### PRIORITY

This application is a divisional of U.S. patent application Ser. No. 17/419,324 filed June 29,2021, which is a National Stage Entry under 35 U.S.C. § 371 from PCT Application PCT/US2020/012203 filed Jan. 3, 2020, which claims priority to U.S. Provisional Patent Application 62/788,200, which was filed on Jan. 4, 2019 and is incorporated herein in its entirety.

### FIELD

The disclosure or invention is generally related to coated microporous membranes or thin films, and, more specifically, to coated microporous membranes or thin films used as battery separators, textiles, filters, or the like.

In at least one aspect, a battery separator comprising a microporous membrane with a coating on one or both sides thereof is disclosed. The coating may comprise, consist of, or consist essentially of an inorganic component and at least one of the following: a wet adhesion polymer and a dry adhesion polymer. In some preferred embodiments, the coating is on only one side of the microporous membrane and in some other preferred embodiments the coating is on both sides of the microporous membrane.

In at least some embodiments, the coating may comprise, consist of, or consist essentially of an inorganic component and a wet adhesion polymer. In some embodiments, the coating comprising, consisting of, or consisting essentially of an inorganic component and a wet adhesion polymer is “inorganic rich” or comprises, consists of, or consists essentially of 50% to 80% inorganic component. In some embodiments, the coating comprising, consisting of, or consisting essentially of an inorganic component and a wet adhesion polymer is “polymer rich” or comprises, consists of, or consists essentially of 10 to less than 50% inorganic component.

In at least selected embodiments where the coating comprises, consists of, or consists essentially of an inorganic component and a wet adhesion polymer, the electrolyte wettability of the coating is <35° contact angle or in some embodiments, a less than 30° contact angle. Sometimes a polymer-rich coating exhibits a contact angle <35° and an inorganic rich coating exhibits a contact angle less than 30°.

In at least certain embodiments where the coating comprises, consists of, or consists essentially of an inorganic component and a wet adhesion polymer, the wet adhesion polymer is a fluoropolymer such as PVDF or PVDF-HFP.

In at least selected embodiments, the coating comprises, consists of, or consists essentially of an inorganic component and a wet adhesion polymer. In some preferred embodiments, the inorganic component and the wet adhesion polymer have similar particle sizes or the inorganic component has a larger average particle size compared to the wet adhesion polymer when the coating is dry. When the coating is wet with electrolyte, in some embodiments, the wet adhesion polymer swells or grows so that the average particle size of the wet adhesion polymer is larger than that of the inorganic component.

In at least certain embodiments, the coating comprises, consists of, or consists essentially of an inorganic component and a dry adhesion polymer. In some embodiments, the dry adhesion polymer has a glass transition temperature less than 100° C., less than 90° C., less than 80° C., or less than 70° C. In some preferred embodiments, the glass transition temperature of the dry adhesion polymer is between 30° C. and 80° C., between 40° C. and 70° C., between 40° C. and 65° C., between 45° C. and 60° C., between 45° C. and 55° C., or between 45° C. and 50° C.

In at least selected embodiments, the coating comprises an inorganic component, a dry adhesion polymer, and a wet adhesion polymer. In some embodiments, the coating is inorganic rich, and in other embodiments, it is polymer rich.

### BACKGROUND

As technological demands increase for lighter, longer lasting, and thinner batteries, demands on battery separator thickness, safety, performance, quality, and manufacture also increase. Various techniques have been developed to improve the performance properties of membranes or porous substrates used as separators in lithium batteries. One area of focus is on various coatings that can be applied to the surface of battery separators to improve one or more performance properties of the separator. Such coatings may be applied using various technologies such as dip coating, knife, gravure, curtain, spray, etc.

Coating development has also focused on improving the safety of batteries, especially preventing thermal runaway in lithium-ion batteries. Abuse conditions, such as overcharge, over-discharge, and internal short-circuits, for example, can lead to the creation of battery temperatures far above safe operating temperatures. Since electrolyte liquids in lithium-ion batteries are often non-aqueous, these liquids can combust at elevated temperatures, causing violent self-destruction of the battery if left unchecked. Shutdown of the battery, e.g., a stopping of ionic flow across the separator between an anode and a cathode, is a safety mechanism used to prevent thermal runaway. Improved separators in certain lithium-ion batteries need to offer the ability to shutdown ionic flow at temperatures at least slightly lower than that at which thermal runaway occurs, while still retaining their mechanical properties. Faster shutdown at lower temperatures and for a longer duration, allowing a user or device additional time to turn off the system, is very desirable.

Another safety and efficiency issue for lithium-ion batteries are shorts (hard or soft) caused when the electrodes contact each other. A hard short can occur if the electrodes come into direct contact with each other and can also occur when large or multiple lithium dendrite growths from the anode comes into contact with the cathode. The result of a hard short is a rapid elevation in temperature that can quickly turn into a thermal runaway event if left unchecked. A soft short can occur when small or limited lithium dendritic growth from the anode comes into contact with the cathode. Soft shorts can reduce the cycling efficiency of the battery. Conventional ceramic-coated separators often display effectiveness at preventing hard or soft shorts, but may have limitations. Thus, there is a constant need to improve the safety and performance of separators and separator coatings.

### SUMMARY

In at least selected embodiments, objects or aspects, the present invention or disclosure may address the above needs, desires or issues, and/or may provide or disclose new or improved coated microporous membranes, porous substrates, base films, or thin films, and/or, more specifically, may provide or disclose new or improved coated microporous membranes, porous substrates, base films, or thin films used as battery separators, textiles, filters, or the like, and/or may provide or disclose new or improved coatings, thin coatings, ultra-thin coatings, or nano-coatings.

Disclosed herein are varieties of novel or improved coated microporous membranes that may be used as battery separators in, for example, secondary batteries such as Li-ion batteries. The coated microporous membranes disclosed herein solve many of the aforementioned problems faced when manufacturing and operating secondary batteries whose battery separators comprise, consist of, or consist essentially of coated microporous membranes.

In at least one aspect, a battery separator comprising a microporous membrane with a coating on one or both sides thereof is disclosed. The coating may comprise, consist of, or consist essentially of an inorganic component and at least one of the following: a wet adhesion polymer and a dry adhesion polymer. In some preferred embodiments, the coating is on only one side of the microporous membrane and in some other preferred embodiments the coating is on both sides of the microporous membrane.

In at least some embodiments, the coating may comprise, consist of, or consist essentially of an inorganic component and a wet adhesion polymer. In some embodiments, the coating comprising, consisting of, or consisting essentially of an inorganic component and a wet adhesion polymer is “inorganic rich” or comprises, consists of, or consists essentially of 50% to 80% inorganic component. In some embodiments, the coating comprising, consisting of, or consisting essentially of an inorganic component and a wet adhesion polymer is “polymer rich” or comprises, consists of, or consists essentially of 10 to less than 50% inorganic component.

In at least selected embodiments where the coating comprises, consists of, or consists essentially of an inorganic component and a wet adhesion polymer, the electrolyte wettability of the coating is <35° contact angle or in some embodiments, a less than 30° contact angle. Sometimes a polymer-rich coating exhibits a contact angle <35° and an inorganic rich coating exhibits a contact angle less than 30°.

In at least certain embodiments where the coating comprises, consists of, or consists essentially of an inorganic component and a wet adhesion polymer, the wet adhesion polymer is a fluoropolymer such as PVDF or PvdF.

In at least selected embodiments, the coating comprises, consists of, or consists essentially of an inorganic component and a wet adhesion polymer. In some preferred embodiments, the inorganic component and the wet adhesion polymer have similar particle sizes or the inorganic component has a larger average particle size compared to the wet adhesion polymer when the coating is dry. When the coating is wet with electrolyte, in some embodiments, the wet adhesion polymer swells or grows so that the average particle size of the wet adhesion polymer is larger than that of the inorganic component.

In at least certain embodiments, the coating comprises, consists of, or consists essentially of an inorganic component and a dry adhesion polymer. In some embodiments, the dry adhesion polymer has a glass transition temperature less than 100° C., less than 90° C., less than 80° C., or less than 70° C. In some preferred embodiments, the glass transition temperature of the dry adhesion polymer is between 30° C. and 80° C., between 40° C. and 70° C., between 40° C. and 65° C., between 45° C. and 60° C., between 45° C. and 55° C., or between 45° C. and 50° C.

In at least selected embodiments, the coating comprises an inorganic component, a dry adhesion polymer, and a wet adhesion polymer. In some embodiments, the coating is inorganic rich, and in other embodiments, it is polymer rich.

In at least some embodiments, the coating comprises, consists of, or consists essentially of an inorganic component and at least one of a dry adhesion polymer and a wet adhesion polymer, and the coating has a thickness less than 5 microns, less than 3 microns, or one micron or less. In some preferred embodiments, the coating has a thickness less than 5 microns, less than 3 microns, or less than or equal to one micron, and at least one of the inorganic component, the dry adhesion polymer, and the wet adhesion polymer has an average particle size between 200 to 600 nm, between 200 to 500 nm, between 300 to 500 nm, between 200 to 400 nm, or between 200 to 300 nm.

In at least selected embodiments, the coating of the battery separator comprises, consists of, or consists essentially of an inorganic component and at least one of a dry adhesion polymer and a wet adhesion polymer, and the coating exhibits at least one of the following: a wet adhesion greater than 30 N/m, a dry adhesion >16 N/m, and an electrolyte absorption greater than or equal to 2 g/sample after 60 min.

In at least one aspect, a battery separator comprising a coating on one or both sides of a microporous membrane is disclosed and the coating comprises, consists of, or consists essentially of a polymer that does at least one of the following: lowers the surface friction coefficient of the microporous membrane and lowers the shutdown onset temperature of the microporous membrane.

In at least selected embodiments, there is disclosed or provided a battery separator comprising a coating on one or both sides of a microporous membrane, wherein the coating comprises a polymer that does at least one of the following: lowers the surface friction coefficient of the microporous membrane and lowers the shutdown onset temperature of the microporous membrane. For example, the coated microporous membrane exhibits lower surface friction coefficient and/or a lower shutdown onset temperature compared to the uncoated microporous membrane (i.e., the microporous membrane without a coating on one or both sides thereof). In some embodiments, the coating comprises, consists of, or consists essentially of the aforementioned polymer and an inorganic component. In some embodiments, the aforementioned polymer that does at least one of lower the surface friction coefficient of the microporous membrane and lower the shutdown onset temperature of the microporous membrane has a melting temperature in the range of 100° C. to 130° C., 110° C. to 130° C., 120° C. to 130° C., or 120° C. to 125° C. In some embodiments, the polymer is a polyethylene, including a polyethylene having a melting point in the aforementioned ranges. In some embodiments, the polymer is included in the coating as a polymeric bead.

In at least certain embodiments, the battery separator comprising a coating with a polymer that lowers the shutdown onset temperature of the microporous membrane exhibits a shutdown onset temperature ≤160° C., ≤150° C., ≤140° C., ≤130° C., ≤120° C., ≤110° C., ≤100° C., ≤90° C., or ≤80° C. In some embodiments, the battery separator comprising a coating with a polymer that lowers the surface friction coefficient exhibits a pin removal force less than 350 N, less than 300 N, less than 250 N, less than 200 N, less than 150 N, or less than 100 N.

In at least another aspect, a battery separator comprising a coating on one or both sides of a microporous membrane is disclosed, and the coating comprises, consists of, or consists essentially of a cross-linked or cross-linkable polymer. In some embodiments, the cross-linked or cross-linkable polymer is or comprises a tri-functional or multi-functional acrylate. In some embodiments, the cross-linked or cross-linkable polymer is a thermosetting polymer. In some embodiments, the cross-linked or cross-linkable polymer comprises di-, tri-, or multi-epoxide monomers. In some embodiments, the coating comprises, consists of, or consists essentially of a cross-linked or cross-linkable polymer and an inorganic component. In some preferred embodiments, that coating does not comprise an inorganic component and only comprises the cross-linked or cross-linkable polymer.

In at least some embodiments, the battery separator with a coating comprising, consisting of, or consisting essentially of a cross-linked polymer exhibits reduced splittiness compared to the microporous membrane itself (uncoated) when subjected to a puncture split test. In some embodiments, the battery separator with a coating comprising, consisting of, or consisting essentially of a cross-linked polymer exhibits reduced standard deviation of TD elongation when compared to the microporous membrane itself (uncoated). In some embodiments, the battery separator with a coating comprising, consisting of, or consisting essentially of a cross-linked polymer exhibits reduced MD shrinkage (%), which is measured at 130° C. for 1 hour, compared to the microporous membrane itself (uncoated). In some embodiments, the battery separator with a coating comprising, consisting of, or consisting essentially of a cross-linked polymer exhibits extended shutdown compared to the microporous membrane itself (uncoated). In some embodiments, the battery separator with a coating comprising, consisting of, or consisting essentially of a cross-linked polymer exhibits increased TD tensile compared to the microporous membrane itself (uncoated). In some embodiments, the battery separator with a coating comprising, consisting of, or consisting essentially of a cross-linked polymer exhibits increased loading when compared to the microporous membrane itself (uncoated). In some embodiments, the battery separator with a coating comprising, consisting of, or consisting essentially of a cross-linked polymer exhibits reduced electrolyte loss (for example, 1% less, 2% less, 3% less, 4% less, . . . ) or slows down electrolyte evaporation (improves electrolyte retention) compared to the microporous membrane itself (uncoated). In some embodiments, the battery separator with a coating comprising, consisting of, or consisting essentially of a cross-linked polymer has a thickness that is not more than 300 nm thicker than the microporous film itself (uncoated). In some embodiments, it is not more than 200 nm thicker, not more than 100 nm thicker, or not more than 50 nm thicker.

In at least another aspect, disclosed is a separator comprising the following: a porous substrate having a first surface and an opposite facing second surface; and a coating positioned on the first surface, on the second surface, or on both the second surface. The coating comprises a first layer having a first density, a second layer having a second density, and the first and second density are different from one another. In some embodiments, the first layer has a density of up to 1.3 g/cm³ or a density from 0.1g/cm³ to 1.3g/cm³. In some embodiments, the second layer has a density of at least 1.3 g/cm³, and in some embodiments, the second layer has a density of 1.3g/cm³ to 3 g/cm³. In some embodiments, the first layer is placed closest to a surface of the porous substrate and in some embodiments the second layer is placed closest to a surface of the porous substrate. When the first layer is placed closest to a surface of the porous substrate, the second layer may be placed over the first layer. When the second layer is placed closest to a surface of the porous substrate, the first layer may be placed over the second layer. In embodiments, where the first layer is placed over the second layer or the second layer is placed over the first layer of the two-layer coating, coverage of the layer placed on top of the other layer covers at least 80% of the layer underneath. In some preferred embodiments, there is at least 85% coverage, at least 90% coverage, at least 95% coverage, or 100% coverage.

In some preferred embodiments, the second layer having a density of at least 1.3g/cm³ is placed closest to a surface of the porous substrate and the first layer having a density up to 1.3g/cm³ is placed on top of the first layer. The first layer may form a continuous layer covering at least 80% of the surface of the second layer. In some embodiments, the second layer comprises, consists of, or consists essentially of an inorganic component and in some embodiments, the second layer may comprise, consist of, or consist essentially of an inorganic component and an organic component. In some embodiments, the second layer comprises at least 50% of an inorganic component. In some embodiments, the first layer may comprise, consist of, or consist essentially of an organic component, and in some embodiments, the first layer may comprise, consist of, or consists essentially of an organic component and an inorganic component. In some embodiments, the first layer may comprise at least 50% of an organic component. In some embodiments, the first layer may be 0.1 to 0.9 microns thick, preferably 0.1 to 0.7 microns thick, and most preferably 0.1 to 0.5 microns thick.

In at least certain embodiments, the organic component comprises, consists of, or consists essentially of the following: methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylbutyl (meth)acrylate, 2-ethylhexyl (meth)acrylate, n-octyl (meth)acrylate, isooctyl (meth)acrylate, isononyl (meth)acrylate, lauryl (meth)acrylate, tetradecyl (meth)acrylate, polyvinylidene difluoride (PVDF), poly(vinylidene fluoride-co-hexafluoropropylene) (PVDF:HFP), polytetrafluoroethylene (PTFE), polyethylene oxide (PEO), poly(vinyl alcohol) (PVA), polyacrylonitrile (PAN), polyacrylamide, polyvinylacetate, polyvinylpyrrolidone, polytetraethylnene glycol diacrylate, a polypropylene (PP) including isotactic PP, high density PP, ultrahigh molecular weight PP, low density PP, a polyethylene (PE) including high density PE, ultrahigh molecular weight PE, low density PE, polyvinyl acetate, polyvinyl chloride, bisphenol-A polycarbonate (BPA-PC), cyclo-olefinic copolymer (COC), a polysulfone (PSF), polyether imide (PEI), polyurethane, acrylonitrile butadiene styrene (ABS), polyimide, polyamide, copolymers of any of the foregoing, or any combination thereof.

In at least selected embodiments, the inorganic component comprises, consists essentially of, or consists of a ceramic, a metal oxide, a metal hydroxide, a metal carbonate, a silicate, kaolin, talc, a mineral, a glass, or any combination thereof. In some embodiments, the inorganic component comprises, consists of, or consists essentially of aluminum oxide (Al₂O₃), boehmite (Al(O)(OH)), titanium oxide (TiO₂), silicon oxide (SiO₂), zinc oxide (ZnO₂), zirconium dioxide (ZrO₂), barium sulfate (BaSO₄), barium titanium oxide (BaTiO₃), aluminum nitride, silicon nitride, calcium fluoride, barium fluoride, zeolite, apatite, kaoline, mullite, spinel, olivine, mica, tin dioxide (SnO₂), indium tin oxide, an oxide of a transition metal, or any combination thereof.

In at least some embodiments, the porous or microporous substrate or membrane (or base film or thin film) used in any of the embodiments described herein is most preferably a single layer, bi-layer, tri-layer, or multilayer dry-process membrane. In some embodiments, the porous substrate or microporous membrane comprises polyolefin. The polyolefin may be, comprise, consist of, or consist essentially of polypropylene, a polypropylene blend, a polypropylene copolymer, a polyethylene, a polyethylene blend, a polyethylene copolymer, or any combination thereof. The porous substrate or microporous membrane may be a bi-layer, tri-layer, or multi-layer dry-process membrane in some embodiments, where each layer comprises the same polyolefin composition as or a different polyolefin composition than the other layers of the porous substrate or microporous membrane.

Although a dry process microporous membrane or porous substrate is most preferred, for example Celgard® dry stretch process polyolefin membrane products from Celgard, LLC of Charlotte, North Carolina, other polymer membrane types may be used, such as wet process, particle stretch, BNBOPP, or the like.

In some embodiments, the microporous membrane or porous substrate has an average pore size of 0.01 nm to 1 μm.

In at least certain embodiments, an additive is added to the porous substrate or microporous membrane. The additive may comprise, consist of, or consist essentially of a functionalized polymer, an ionomer, a cellulose nanofiber, an inorganic particle, a lubricating agent, a nucleating agent, a cavitation promoter, a fluoropolymer, a cross-linker, an x-ray detectable material, a polymer processing agent, a high temperature melt index (HTMI) polymer, an electrolyte additive, an energy dissipative non-miscible additive, or any combination thereof.

In one aspect, a method of preparing a separator having a different densities coating is described. The method comprises: coating a first surface, an opposite facing second surface, or both the first surface and the second surface of a porous substrate with a first layer and a second layer, the first layer having a first density and the second layer having a second density that is different from the first density.

In another aspect, a battery separator is disclosed. The battery separator may comprise, consist of, or consist essentially of: a porous substrate having a first surface and an opposite facing second surface; and a coating positioned on the first surface, on the second surface, or on both the first and second surfaces of the porous substrate, the coating comprises an inorganic component and a sticky polymer. In some embodiments, the sticky polymer may be selected from a “dry sticky” polymer with a glass transition temperature less than 100° C. and preferably less than 70° C., a “wet sticky” polymer that swells and gels in non-aqueous electrolyte, and combinations thereof. In some embodiments, the sticky polymer is a “wet sticky” polymer that comprises, consists of, or consists essentially of a fluoropolymer.

In some embodiments, the sticky polymer is a first size when dry and a second size when wet with electrolyte, with the first size being smaller than the second size. In some embodiments, the sticky polymer is one that swells from a first size to a second larger size upon absorption of an electrolyte. In some embodiments, the battery separator described herein has an inorganic component that extends further outward or sticks out from the first and/or second surface when the battery separator is dry, and when the battery separator is wet with electrolyte, the sticky polymer swells from a first size to a second size so that the sticky polymer extends further outward from the first and/or second surfaces of the substrate than the inorganic component. In some embodiments, the swollen sticky polymer covers the inorganic component and the inorganic component is not exposed at the surface of the battery separator. In some embodiments, the inorganic component is substantially covered by the swollen sticky polymer. In some embodiments, both the inorganic component and the sticky polymer are exposed on the first and/or second surfaces of the substrate when the separator is dry, and when the separator is wet, mainly or only the sticky polymer is exposed.

The inorganic component may comprise, consist of, or consist essentially of a ceramic, a metal oxide, a metal hydroxide, a metal carbonate, a silicate, kaolin, talc, a mineral, a glass, or any combination thereof. Sometimes, the inorganic component may comprise, consist of, or consist essentially of aluminum oxide (Al₂O₃), boehmite (Al(O)(OH)), titanium oxide (TiO₂), silicon oxide (SiO₂), zinc oxide (ZnO₂), zirconium dioxide (ZrO₂), barium sulfate (BaSO₄), barium titanium oxide (BaTiO₃), aluminum nitride, silicon nitride, calcium fluoride, barium fluoride, zeolite, apatite, kaoline, mullite, spinel, olivine, mica, tin dioxide (SnO₂), indium tin oxide, an oxide of a transition metal, or any combination thereof.

In some embodiments, the sticky polymer comprises, consists of, or consists essentially of methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylbutyl (meth)acrylate, 2-ethylhexyl (meth)acrylate, n-octyl (meth)acrylate, isooctyl (meth)acrylate, isononyl (meth)acrylate, lauryl (meth)acrylate, tetradecyl (meth)acrylate, polyvinylidene difluoride (PVDF), poly(vinylidene fluoride-co-hexafluoropropylene) (PVDF:HFP), polytetrafluoroethylene (PTFE), polyethylene oxide (PEO), poly(vinyl alcohol) (PVA), polyacrylonitrile (PAN), polyacrylamide, polyvinylacetate, polyvinylpyrrolidone, polytetraethylnene glycol diacrylate, a polypropylene (PP) including isotactic PP, high density PP, ultrahigh molecular weight PP, low density PP, a polyethylene (PE) including high density PE, ultrahigh molecular weight PE, low density PE, polyvinyl acetate, polyvinyl chloride, bisphenol-A polycarbonate (BPA-PC), cyclo-olefinic copolymer (COC), a polysulfone (PSF), polyether imide (PEI), polyurethane, acrylonitrile butadiene styrene (ABS), polyimide, polyamide, copolymers of any of the foregoing, or any combination thereof.

In some embodiments, the coating has a thickness of 0.1 to 0.9 microns. In some embodiments, the coating has a thickness from 0.1 to 0.7 microns. In some embodiments, the coating has a thickness from 0.1 to 0.5 microns.

In another aspect, a battery separator is disclosed herein. The battery separator may comprise, consist of, or consist essentially of: a porous substrate having a first surface and an opposite facing second surface; and a coating positioned on the first surface, on the second surface, or on both the first and second surfaces of the porous substrate, the coating comprising an electrolyte absorbing material.

In some embodiments, the coating further comprises a first thermally activated polymer positioned over the electrolyte absorbing material. In such an embodiment, the electrolyte absorbing material is encapsulated between the first thermally activated polymer and the porous substrate.

In some other embodiments, the electrolyte absorbing material is substantially encapsulated inside a plurality of polymer microcapsules, the microcapsules comprising the first thermally activated polymer. In some embodiments, the coating further comprises a second thermally activated polymer covering the layer of microencapsulated electrolyte absorbing material.

In some embodiments, the first thermally activated polymer has a melting point of 80° C. to 200° C., 80° C. to 150° C., 80° C. to 140° C., 80° C. to 130° C., 80° C. to 120° C., 80° C. to 110° C., 80° C. to 100° C., or 80° C. to 90° C. In some embodiments, the electrolyte absorbing material is uncovered upon melting of the first thermally activated polymer and can absorb electrolyte.

In some embodiments where a second thermally activated polymer is used, the first thermally activated polymer has a melting point of 80° C. to 200° C., and the second thermally activated polymer has lower melting point. In these embodiments, the electrolyte absorbing material is exposed upon melting of the first and second thermally activated polymers.

In some embodiments, the electrolyte absorbing material comprises, consists of, or consists essentially of aluminum oxide (Al₂O₃), boehmite (Al(O)(OH)), titanium oxide (TiO₂), silicon oxide (SiO₂), zinc oxide (ZnO₂), zirconium dioxide (ZrO₂), barium sulfate (BaSO₄), barium titanium oxide (BaTiO₃), aluminum nitride, silicon nitride, calcium fluoride, barium fluoride, zeolite, apatite, kaoline, mullite, spinel, olivine, mica, tin dioxide (SnO₂), indium tin oxide, an oxide of a transition metal, a ceramic, a metal oxide, a metal hydroxide, a metal carbonate, a silicate, kaolin, talc, a mineral, a glass, or any combination thereof. In some embodiments, the electrolyte absorbing material has a high porosity of 40% or more, 50% or more, 60% or more, 70% or more, 80% or more, or 90% or more.

In some embodiments, the first thermally activated polymer comprises, consists of, or consists essentially of methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylbutyl (meth)acrylate, 2-ethylhexyl (meth)acrylate, n-octyl (meth)acrylate, isooctyl (meth)acrylate, isononyl (meth)acrylate, lauryl (meth)acrylate, tetradecyl (meth)acrylate, polyvinylidene difluoride (PVDF), poly(vinylidene fluoride-co-hexafluoropropylene) (PVDF:HFP), polytetrafluoroethylene (PTFE), polyethylene oxide (PEO), poly(vinyl alcohol) (PVA), polyacrylonitrile (PAN), polyacrylamide, polyvinylacetate, polyvinylpyrrolidone, polytetraethylnene glycol diacrylate, a polypropylene (PP) including isotactic PP, high density PP, ultrahigh molecular weight PP, low density PP, a polyethylene (PE) including high density PE, ultrahigh molecular weight PE, low density PE, polyvinyl acetate, polyvinyl chloride, bisphenol-A polycarbonate (BPA-PC), cyclo-olefinic copolymer (COC), a polysulfone (PSF), polyether imide (PEI), polyurethane, acrylonitrile butadiene styrene (ABS), polyimide, polyamide, copolymers of any of the foregoing, or any combination thereof.

In some embodiments, the second thermally activated polymer comprises, consists of, or consists essentially of methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylbutyl (meth)acrylate, 2-ethylhexyl (meth)acrylate, n-octyl (meth)acrylate, isooctyl (meth)acrylate, isononyl (meth)acrylate, lauryl (meth)acrylate, tetradecyl (meth)acrylate, polyvinylidene difluoride (PVDF), poly(vinylidene fluoride-co-hexafluoropropylene) (PVDF:HFP), polytetrafluoroethylene (PTFE), polyethylene oxide (PEO), poly(vinyl alcohol) (PVA), polyacrylonitrile (PAN), polyacrylamide, polyvinylacetate, polyvinylpyrrolidone, polytetraethylnene glycol diacrylate, a polypropylene (PP) including isotactic PP, high density PP, ultrahigh molecular weight PP, low density PP, a polyethylene (PE) including high density PE, ultrahigh molecular weight PE, low density PE, polyvinyl acetate, polyvinyl chloride, bisphenol-A polycarbonate (BPA-PC), cyclo-olefinic copolymer (COC), a polysulfone (PSF), polyether imide (PEI), polyurethane, acrylonitrile butadiene styrene (ABS), polyimide, polyamide, copolymers of any of the foregoing, or any combination thereof.

In some embodiments, the porous substrate comprises a single layer, bi-layer, tri-layer, or multilayer dry-process membrane. The porous substrate may comprise polyolefin. The polyolefin may comprise, consist of, or consist essentially of a polypropylene, a polypropylene blend, a polypropylene copolymer, a polyethylene, a polyethylene blend, a polyethylene copolymer, or any combination thereof. In some embodiments, the porous substrate comprises, consists of, or consists essentially of a bi-layer, tri-layer, or multilayer dry-process membrane and each layer comprises the same polyolefin composition or a different polyolefin composition as the other layers of the porous substrate.

In another aspect, a method of battery self-defense to a thermal event is disclosed. This method may comprise, consist of, or consist essentially of the following: melting, in a battery environment, a first thermally activated polymer in a battery separator to uncover an electrolyte absorbing material, wherein the battery separator is a battery separator as described hereinabove. In some embodiments, the uncovered electrolyte absorbing material is exposed to electrolyte present in the battery environment. In some embodiments, the exposed electrolyte absorbing material absorbs electrolyte.

In some embodiments of the method disclosed herein, the first thermally activated polymer and the electrolyte absorbing material are positioned between a second thermally-activated polymer and a porous substrate. The second thermally activated polymer has, in some embodiments, a composition that is the same as or different than that of the first thermally-activated polymer.

In some embodiments, the second thermally-activated polymer may have a melting point that is lower than that of the first thermally-activated polymer. The second thermally-activated polymer may be melted first, exposing the underlying first thermally-activated polymer which may be encapsulating the electrolyte absorbing material. In some embodiments, the first thermally-activated polymer may be melted after the second thermally-activated polymer is melted and the electrolyte absorbing material may be exposed.

In another aspect, a method is disclosed herein. The method comprises, consists of, or consists essentially of the following: melting the second thermally activated polymer to form an electrolyte excluding barrier on a surface of the porous substrate. In some embodiments, the second thermally activated polymer encapsulates at least a portion of the uncovered electrolyte of the uncovered electrolyte absorbing material upon melting.

In another aspect, a secondary battery comprising any battery separator described herein is disclosed. The secondary battery may be a lithium-ion battery. The secondary battery may be a cylindrical-type, prismatic-type, stack-type, or pouch-type battery.

In another aspect, a vehicle or device comprising a secondary battery as described herein is disclosed. The vehicle or device may be at least one selected from a cell phone, a laptop, a tablet, an e-vehicle, and a hybrid vehicle.

### BRIEF DESCRIPTION OF THE DRAWINGS

FIG. 1 is a cross-sectional view of a porous substrate having a coating on one surface.

FIG. 2 is a cross-sectional view of a porous substrate having a first layer on two surfaces.

FIG. 3 is a cross-sectional view of a porous substrate having a second layer on two surfaces.

FIG. 4 is a cross-sectional view of a porous substrate having a coating on two surfaces.

FIG. 5 is a cross-sectional view of a porous substrate having a coating on two surfaces.

FIG. 6 is a cross-sectional view of a porous substrate having a coating on one surface and a first layer on another surface.

FIG. 7 is a cross-sectional view of a porous substrate having a coating on one surface and a second layer on another surface.

FIG. 8 is a cross-sectional view of a porous substrate having a coating on one surface and a first layer on another surface.

FIG. 9 is a cross-sectional view of a porous substrate having a coating on one surface and a second layer on another surface.

FIG. 10 is a cross-sectional view of a porous substrate having a first coating on one surface and a second coating on another surface.

FIG. 11A is a cross-sectional view of a porous substrate having a coating on one surface, the coating being in a dry state.

FIG. 11B is a cross-sectional view of a porous substrate having the coating of FIG. 11A on one surface, the coating being in a wet state.

FIG. 12 is a cross-sectional view of a porous substrate having a first thermally active polymer layer positioned between a second thermally active polymer layer and the porous substrate.

FIG. 13 is a cross-sectional view of a porous substrate having a coating on one surface, the coating being an electrolyte absorbing material substantially encapsulated inside a plurality of polymer microcapsules.

FIG. 14 is a cross-sectional view of a porous substrate described in FIG. 13, further comprising a second thermally activated polymer covering the microencapsulated electrolyte absorbing material. FIG. 15 is a schematic drawing of a coated separator according to some embodiments described herein.

FIG. 16 has a cross section SEM image and a surface SEM image of a coated separator according to some embodiments described herein.

FIG. 17 shows images of electrolyte wettability of coated separators according to some embodiments described herein compared to uncoated microporous membrane or base film.

FIG. 18 shows images of electrolyte wettability of a coated separator according to some embodiments described herein compared to uncoated microporous membrane or basefilm, CCS, and PCS.

FIG. 19 is a chart showing average dry and wet adhesion of coated separators according to some embodiments described herein.

FIG. 20 shows an image of electrode material transferred after peel off when adhesion of coated separators according to some embodiments described herein are tested.

FIG. 21 is a graph of electrolyte absorption for coated separators according to some embodiments described herein and comparative products.

FIG. 22 shows shutdown behavior for coated microporous membranes according to some embodiments described herein compared to the uncoated microporous membrane.

FIG. 23 is a graph showing pin removal force for some coated microporous membranes described herein compared to the uncoated microporous membrane.

FIG. 24 is a graph showing benefits of cross-linked coatings.

FIG. 25 shows shutdown behavior for a coated microporous membrane according to some embodiments described herein compared to uncoated microporous membrane.

FIG. 26 shows images of results of a puncture test for a coated microporous membrane according to some embodiments described herein compared to the uncoated microporous membrane.

FIG. 27 shows compressive extension results for some coated microporous membrane according to some embodiments described herein.

FIG. 28 shows TMA(MD), TMA(TD), and electrolyte loss results for some coated microporous membrane embodiments described herein compared to comparative uncoated microporous membranes.

### DETAILED DESCRIPTION

In at least one aspect, a battery separator comprising a microporous membrane with a coating on one or both sides thereof is disclosed. The coating may comprise, consist of, or consist essentially of an inorganic component and at least one of the following: a wet adhesion polymer and a dry adhesion polymer. In some preferred embodiments, the coating is on only one side of the microporous membrane and in some other preferred embodiments the coating is on both sides of the microporous membrane.

In at least some embodiments, the coating may comprise, consist of, or consist essentially of an inorganic component and a wet adhesion polymer. In some embodiments, the coating comprising, consisting of, or consisting essentially of an inorganic component and a wet adhesion polymer is “inorganic rich” or comprises, consists of, or consists essentially of 50% to 80% inorganic component. In some embodiments, the coating comprising, consisting of, or consisting essentially of an inorganic component and a wet adhesion polymer is “polymer rich” or comprises, consists of, or consists essentially of 10 to less than 50% inorganic component.

In at least selected embodiments where the coating comprises, consists of, or consists essentially of an inorganic component and a wet adhesion polymer, the electrolyte wettability of the coating is <35° contact angle or in some embodiments, a less than 30° contact angle. Sometimes a polymer-rich coating exhibits a contact angle <35° and an inorganic rich coating exhibits a contact angle less than 30°.

In at least certain embodiments where the coating comprises, consists of, or consists essentially of an inorganic component and a wet adhesion polymer, the wet adhesion polymer is a fluoropolymer such as PVDF.

In at least selected embodiments, the coating comprises, consists of, or consists essentially of an inorganic component and a wet adhesion polymer. In some preferred embodiments, the inorganic component and the wet adhesion polymer have similar particle sizes or the inorganic component has a larger average particle size compared to the wet adhesion polymer when the coating is dry. When the coating is wet with electrolyte, in some embodiments, the wet adhesion polymer swells or grows so that the average particle size of the wet adhesion polymer is larger than that of the inorganic component.

In at least certain embodiments, the coating comprises, consists of, or consists essentially of an inorganic component and a dry adhesion polymer. In some embodiments, the dry adhesion polymer has a glass transition temperature less than 100° C., less than 90° C., less than 80° C., or less than 70° C. In some preferred embodiments, the glass transition temperature of the dry adhesion polymer is between 30° C. and 80° C., between 40° C. and 70° C., between 40° C. and 65° C., between 45° C. and 60° C., between 45° C. and 55° C., or between 45° C. and 50° C.

In at least selected embodiments, the coating comprises an inorganic component, a dry adhesion polymer, and a wet adhesion polymer. In some embodiments, the coating is inorganic rich, and in other embodiments, it is polymer rich.

### I. Coated Separator 1

In one aspect, a coated, porous or microporous thin film, base film, membrane, separator, or substrate (hereinafter “coated separator” or “separator”) is described herein that can offer one or more advantages over conventional uncoated substrates. In some embodiments, a separator described herein comprises a porous substrate having a first surface and an opposite facing second surface; and a coating positioned on the first surface, on the second surface, or on both the first and second surfaces of the porous substrate. The coating may comprise a first layer having a first density, and a second layer having a second density, the second density being different from the first density.

A substrate described herein can comprise one or more layers comprising one or more of a polyolefin, a fluorocarbon, a polyamide, a polyester, a polyacetal (or a polyoxymethylene), a polysulfide, a polyvinyl alcohol, a polyvinylidene, co-polymers thereof, or combinations thereof. In some embodiments, a substrate described herein comprises a polyolefin comprising a polypropylene, a polyethylene, a blend of polyolefins, one or more co-polymers of a polyolefin, or any combination thereof.

A polyolefin can include, but is not limited to: a polyethylene, a polypropylene, a polybutylene, a polymethylpentene, a copolymer thereof, and a blend thereof. In some embodiments, a polyolefin can be an ultra-low molecular weight, a low-molecular weight, a medium molecular weight, a high molecular weight, or an ultra-high molecular weight polyolefin, such as a medium or a high weight polyethylene (PE) or polypropylene (PP). For example, an ultra-high molecular weight polyolefin can have a molecular weight of 450,000 (450 k) or above, e.g. 500 k or above, 650 k or above, 700 k or above, 800 k or above, 1 million or above, 2 million or above, 3 million or above, 4 million or above, 5 million or above, 6 million or above, and so on. A high-molecular weight polyolefin can have a molecular weight in the range of 250 k to 450 k, such as 250 k to 400 k, 250 k to 350 k, or 250 k to 300 k. A medium molecular weight polyolefin can have a molecular weight from 150 to 250 k, such as 100 k, 125k, 130K, 140 k, 150 k to 225 k, 150 k to 200 k, 150 k to 200 k, and so on. A low molecular weight polyolefin can have a molecular weight in the range of 100 k to 150 k, such as 100 k to 125 k. An ultra-low molecular weight polyolefin can have a molecular weight less than 100 k. The foregoing values are weight average molecular weights. In some embodiments, a higher molecular weight polyolefin can be used to increase strength or other properties of the porous substrate or batteries comprising the same as described herein. In some embodiments, a lower molecular weight polymer, such as a medium, low, or ultra-low molecular weight polymer can be beneficial. For example, without wishing to be bound by any particular theory, it is believed that the crystallization behavior of lower molecular weight polyolefins can result in a porous substrate having smaller pores resulting from at least an MD stretching process that forms the pores.

Fluorocarbons can comprise polytetrafluoroethylene (PTFE), polychlorotrifluoroethylene (PCTFE), fluorinated ethylene propylene (FEP), ethylenechlortrifluoroethylene (ECTFE), ethylene tetrafluoroethylene (ETFE), polyvinylidene fluoride (PVDF), polyvinylfluoride (PVF), prefluoroalkoxy (PFA) resin, co-polymers thereof, or combinations thereof. Polyamides can comprise, but are not limited to: polyamide 6, polyamide 6/6, Nylon 10/10, polyphthalamide (PPA), co-polymers thereof, or combinations thereof. Polyesters can comprise polyester terephthalate (PET), polybutylene terephthalate (PBT), poly-1-4-cyclohexylenedimethylene terephthalate (PCT), polyethylene naphthalate (PEN), or liquid crystal polymers (LCP). Polysulfides can comprise, but are not limited to, polyphenylsulfide, polyethylene sulfide, co-polymers thereof, or combinations thereof. Polyvinyl alcohols can comprise, but are not limited to, ethylenevinyl alcohol, co-polymers thereof, or combinations thereof. Polyvinylidenes include, but are not limited to: fluorinated polyvinylidenes (such as polyvinylidene chloride, polyvinylidene fluoride), copolymers thereof, and blends thereof

A substrate can in some instances comprise a semi-crystalline polymer, such as polymers having a crystallinity in the range of 20 to 80%.

In some embodiments, a substrate described herein can comprise a single layer, a bi-layer, a tri-layer, or multilayers. For example, a tri-layer or multilayer substrate can comprise two outer layers and one or more inner layers. In some instances, a substrate can comprise 1, 2, 3, 4, 5, or more inner layers. As described in more detail below, each of the layers can be coextruded and/or laminated together.

A substrate described herein can be made by a dry stretch process (such as a Celgard® dry stretch process described herein) in which one or more polymers are extruded to form the substrate. Each of the outer and inner layers can be mono-extruded, where the layer is extruded by itself, without any sublayers (plies), or each layer can comprise a plurality of co-extruded sublayers. For example, each layer can comprise a plurality of sublayers, such as a co-extruded bi-sublayer, tri-sublayer, or multi-sublayer substrate, each of which can collectively considered to be a “layer”. The number of sublayers in coextruded bi-layer is two, the number of layers in a co-extruded tri-layer is three, and the number of layers in a co-extruded multi-layer substrate will be two or more, three or more, four or more, five or more, and so on. The exact number of sublayers in a co-extruded layer is dictated by the die design and not necessarily the materials that are co-extruded to form the co-extruded layer. For example, a co-extruded bi-, tri-, or multi-sublayer substrate can be formed using the same material in each of the two, three, or four or more sublayers, and these sublayers will still be considered to be separate sublayers even though each sublayer is made of the same material.

In some embodiments, a tri-layer or multilayer substrate described herein can comprise two outer layers (such as a first outer layer and a second outer layer) and a single or plurality of inner layers. The plurality of inner layers can be mono-extruded or co-extruded layers. A lamination barrier can be formed between each of the inner layers and/or between each of the outer layers and one of the inner layers. A lamination barrier can be formed when two surfaces, such as two surfaces of different substrates or layers are laminated together using heat, pressure, or heat and pressure.

In some embodiments, a substrate described herein can have the following non-limiting constructions: PP, PE, PP/PP, PP/PE, PE/PP, PE/PE, PP/PP/PP, PP/PP/PE, PP/PE/PE. PP/PE/PP, PE/PP/PE, PE/PE/PP, PP/PP/PP/PP, PP/PE/PE/PP, PE/PP/PP/PE, PP/PE/PP/PP, PE/PE/PP/PP, PE/PP/PE/PP, PP/PE/PE/PE/PP, PE/PP/PP/PP/PE, PP/PP/PE/PP/PP, PE/PE/PP/PP/PE/PE, PP/PE/PP/PE/PP, PP/PP/PE/PE/PP/PP, PE/PE/PP/PP/PE/PE, PE/PP/PE/PP/PE/PP, PP/PE/PP/PE/PP/PE, PP/PP/PP/PE/PP/PP/PP, PE/PE/PE/PP/PE/PE/PE, PP/PE/PP/PE/PP/PE/PP, PE/PP/PE/PP/PE/PP/PE, PE/PP/PE/PP/PE/PP/PE/PP, PP/PE/PP/PE/PP/PE/PP/PE, PP/PP/PE/PE/PP/PP/PE/PE, PP/PE/PE/PE/PE/PE/PE/PP, PE/PP/PP/PP/PP/PP/PP/PE, PP/PP/PE/PE/PEPE/PP/PP, PP/PP/PP/PP/PE/PE/PE/PE, PP/PP/PP/PP/PE/PP/PP/PP/PP, PE/PE/PE/PE/PP/PE/PE/PE/PE, PP/PE/PP/PE/PP/PE/PP/PE/PP, PE/PP/PE/PP/PE/PP/PE/PP/PE, PE/PE/PE/PE/PE/PP/PP/PP/PP, PP/PP/PP/PP/PP/PE/PE/PE/PE, PP/PP/PP/PP/PP/PE/PE/PE/PE/PE, PE/PE/PE/PE/PE/PP/PP/PP/PP/PP, PP/PE/PP/PE/PP/PE/PP/PE/PP/PE, PE/PP/PE/PP/PE/PP/PE/PP/PE/PP, PE/PP/PP/PP/PP/PP/PP/PP/PP/PP/PE, PP/PE/PE/PE/PE/PE/PE/PE/PE/PE/PP, PP/PP/PE/PE/PP/PP/PE/PE/PP/PP, PE/PE/PP/PP/PP/PP/PP/PP/PP/PE/PE, PP/PP/PP/PE/PE/PP/PP/PP/PP/PE, or PE/PE/PE/PP/PP/PE/PE/PE/PP/PP. For purposes of reference herein PE denotes a single layer within the multilayer substrate that comprises PE. Similarly, PP denotes a single layer within the multilayer substrate that comprises PP. Thus, a PP/PE designation would represent a bi-layer substrate having a polypropylene (PP) layer and a polyethylene (PE) layer.

Individual layers in a substrate can comprise a plurality of sublayers, which can be formed by co-extrusion or combining the individual sublayers to form the individual layer of the multilayer substrate. Using a multilayer substrate having a structure of PP/PE/PP, each individual PP or PE layer can comprise two or more co-extruded sublayers. For example, when each individual PP or PE layer comprises three sublayers, each individual PP layer can be expressed as PP=(PP1, PP2, PP3) and each individual PE layer can be expressed as PE=(PE1, PE2, PE3). Thus, the structure of PP/PE/PP can be expressed as (PP1,PP2,PP3)/(PE1,PE2,PE3)/(PP1,PP2,PP3). The composition of each of the PP1, PP2, and PP3 sublayers can be the same, or each sublayer can have a different polypropylene composition than one or both of the other polypropylene sublayers. Similarly, composition of each of the PE1, PE2, and PE3 sublayers can be the same, or each sublayer can have a different polyethylene composition than one or both of the other polyethylene sublayers. This principle applies to other multilayer substrates having more or less layers that the above-described exemplary tri-layer substrate.

In some embodiments, a substrate described herein has an overall thickness of 1 micron to 60 microns, 1 micron to 55 microns, 1 micron to 50 microns, 1 micron to 45 microns, 1 micron to 40 microns, 1 micron to 35 microns, 1 micron to 30 microns, 1 micron to 25 microns, 1 micron to 20 microns, 1 micron to 15 microns, 1 micron to 10 microns, 5 microns to 50 microns, 5 microns to 40 microns, 5 microns to 30 microns, 5 microns to 25 microns, 5 microns to 20 microns, 5 microns to 10 microns, 10 microns to 40 microns, 10 microns to 35 microns, 10 microns to 30 microns, or 10 microns to 20 microns.

In some embodiments, each layer in bi-layer, tri-layer, or multi-layer substrate can have a thickness equal to a thickness of the other layers, or have a thickness that is less than or greater than a thickness of the other layers. For example, when a substrate is a tri-layer substrate comprising a structure of PP/PE/PP (polypropylene/polyethylene/polypropylene) or PE/PP/PE (polyethylene/polypropylene/polyethylene), the polypropylene layers can have a thickness equal to a thickness of the polyethylene layer(s), have a thickness less than a thickness of the polyethylene layer(s), or have a thickness greater than a thickness of the polyethylene layer(s).

In some embodiments, a substrate described herein can be a tri-layer laminated PP/PE/PP (polypropylene/polyethylene/polypropylene) or a PE/PP/PE (polyethylene/polypropylene/polyethylene) substrate. In some instances, a structure ratio of the layers of the substrate can comprise 45/10/45%, 40/20/40%, 39/22/39%, 38/24/38%, 37/26/37%, 36/28/36%, 35/30/35%, 34.5/31/34.5%, 34/32/34%, 33.5/33/33.5%, 33/34/33%, 32.5/35/32.5%, 32/36/32%, 31.5/37/31.5%, 31/38/31%, 30.5/39/30.5%, 30/40/30%, 29.5/41/29.5%, 29/42/29%, 28.5/43/28.5%, 28/44/28%, 27.5/45/27.5%, or 27/46/27%.

A substrate described herein can additionally comprise fillers, elastomers, wetting agents, lubricants, flame-retardants, nucleating agents, antioxidants, colorants, and/or other additional elements not inconsistent with the objectives of this disclosure. For example, the substrate can comprise fillers such as calcium carbonate, zinc oxide, diatomaceous earth, talc, kaolin, synthetic silica, mica, clay, boron nitride, silicon dioxide, titanium dioxide, barium sulfate, aluminum hydroxide, magnesium hydroxide and the like, or combinations thereof. Elastomers can comprise ethylene-propylene (EPR), ethylene-propylene-diene (EPDM), styrene-butadiene (SBR), styrene isoprene (SIR), ethylidene norbornene (ENB), epoxy, and polyurethane or combinations thereof. Wetting agents can comprise ethoxylated alcohols, primary polymeric carboxylic acids, glycols (such as polypropylene glycol and polyethylene glycols), functionalized polyolefins, and the like. Lubricants can comprise a silicone, a fluoropolymer, oleamide, stearamide, erucamide, calcium stearate, lithium stearate, or other metallic stearates. Flame-retardants can comprise brominated flame-retardants, ammonium phosphate, ammonium hydroxide, alumina trihydrate, and phosphate ester. Nucleating agents can comprise any nucleating agents not inconsistent with the objectives of this disclosure, such as beta-nucleating agents for polypropylene, which is disclosed in U.S. Pat. No. 6,602,593.

A substrate described in some of the embodiments herein, can in some instances, be made by a dry-stretch process. A substrate is understood to be a thin, pliable, polymeric membrane, film, sheet, foil, or substrate having a plurality of pores extending there through. In some cases, the porous substrate is made by the dry-stretch process (also known as the CELGARD® dry stretch process), which refers to a process where pore formation results from stretching a nonporous, semicrystalline, extruded polymer precursor in the machine direction (MD), transverse direction (TD), or in both an MD and TD. See, for example, Kesting, Robert E., Synthetic Polymeric Membranes, A Structural Perspective, Second Edition, John Wiley & Sons, New York, N.Y., (1985), pages 290-297, incorporated herein by reference. Such a dry-stretch process is different from the wet process and the particle stretch process. Generally, in the wet process, also known as a phase inversion process, an extraction process, or a TIPS process, a polymeric raw material is mixed with a processing oil (sometimes referred to as a plasticizer), this mixture is extruded, and pores are formed when the processing oil is removed. While these wet process substrates may be stretched before or after the removal of the oil, the principle pore formation mechanism is the use of the processing oil. See, for example, Kesting, Ibid. pages 237-286, incorporated herein by reference. A particle stretch process uses particles, such as silica or calcium carbonate, as the pore former. The polymeric raw material is mixed with the particles, this mixture is extruded, and pores are formed when the particles are removed. While these particle-filled substrates may be stretched before or after the removal of the particles, the principle pore formation mechanism is the use of the particles. A porous substrate described herein can in some instances preferably be any Celgard® polyolefin microporous separator substrate available from Celgard, LLC of Charlotte, N.C.

A porous substrate can be a macroporous substrate, a mesoporous substrate, a microporous substrate, or a nanoporous substrate. The porosity of the substrate can be any porosity not inconsistent with the goals of this disclosure. For example, any porosity that could form an acceptable battery separator is acceptable. In some embodiments, the porosity of the porous substrate is from 20 to 90%, from 20 to 80%, from 40 to 80%, from 20 to 70%, from 40 to 70%, from 40-60%, more than 20%, more than 30%, or more than 40%. Porosity is measured using ASTM D-2873 and is defined as the percentage of void space, e.g., pores, in an area of the porous substrate, measured in the Machine Direction (MD) and the Transverse Direction (TD) of the substrate. In some embodiments, the pores are slit like, are round with a sphericity factor of 0.25 to 8.0, are oblong, are trapezoidal, or are oval-shaped.

A substrate can have any Gurley not inconsistent with the objectives of this disclosure, such as a Gurly that is acceptable for use as a battery separator. Gurley is the Japanese Industrial Standard (JIS Gurley) and can be measured using a permeability tester, such as an OHKEN permeability tester. JIS Gurley is defined as the time in seconds required for 100 cc of air to pass through one square inch of substrate at a constant pressure of 4.9 inches of water. In some embodiments, the porous film or substrate described herein has a JIS Gurley (s/100 cc) of 100 or more, 150 or more, 160 or more, 170 or more, 180 or more, 190 or more, 200 or more, 210 or more, 220 or more, 230 or more, 240 or more, 250 or more, 260 or more, 270 or more, 280 or more, 290 or more, 300 or more, 310 or more, 320 or more, 330 or more, 340 or more, 350 or more, 100 to 800, 200 to 700, 200 to 600, 200 to 500, 200 to 400, 200 to 300, or 300 to 600.

A substrate can have a puncture strength, uncoated, of 200 gf or more, 210 gf or more, 220 gf or more, 230 gf or more, 240 gf or more, 250 gf or more, 260 gf or more, 270 gf or more, 280 gf or more, 290 gf or more, 300 gf or more, 310 gf or more, 320 gf or more, 330 gf or more, 340 gf or more, 350 gf or more, or as high as 400 gf or more.

In some embodiments, a substrate described herein can comprise one or more additives in at least one layer of the porous substrate. In some embodiments, at least one layer of a porous substrate comprises more than one, such as two, three, four, five, or more, additives. Additives can be present in one or both of the outermost layers of the porous substrate, in one or more inner layers, in all of the inner layers, or in all of the inner and both of the outermost layers. In some embodiments, additives can be present in one or more outermost layers and in one or more innermost layers. In such embodiments, over time, an additive can be released from the outermost layer or layers and the additive supply of the outermost layer or layers can be replenished by migration of the additive in the inner layers to the outermost layers. In some embodiments, each layer of a substrate can comprise a different additive or combination of additives than an adjacent layer of the substrate.

In some embodiments, an additive comprises a functionalized polymer. As understood by one of ordinary skill in the art, a functionalized polymer is a polymer with functional groups coming off the polymeric backbone. In some embodiments, the functionalized polymer is a maleic anhydride functionalized polymer. In some embodiments the maleic anhydride modified polymer is a maleic anhydride homo-polymer polypropylene, copolymer polypropylene, high density polypropylene, low-density polypropylene, ultra-high density polypropylene, ultra-low density polypropylene, homo-polymer polyethylene, copolymer polyethylene, high density polyethylene, low-density polyethylene, ultra-high density polyethylene, ultra-low density polyethylene,

In some embodiments, an additive comprises an ionomer. An ionomer, as understood by one of ordinary skill in the art is a copolymer containing both ion-containing and non-ionic repeating groups. Sometimes the ion-containing repeating groups can make up less than 25%, less than 20%, or less than 15% of the ionomer. In some embodiments, the ionomer can be a Li-based, Na-based, or Zn-based ionomer.

In some embodiments, an additive comprises cellulose nanofiber.

In some embodiments, an additive comprises inorganic particles having a narrow size distribution. For example, the difference between D10 and D90 in a distribution is less than 100 nanometers, less than 90 nanometers, less than 80 nanometers, less than 70 nanometers, less than 60 nanometers, less than 50 nanometers, less than 40 nanometers, less than 30 nanometers, less than 20 nanometers, or less than 10 nanometers. In some embodiments, the inorganic particles are selected from at least one of SiO₂, TiO₂, or combinations thereof.

In some embodiments, an additive comprises a lubricating agent. A lubricating agent or lubricant described herein can be any lubricating agent not inconsistent with the objectives of this disclosure. As understood by one of ordinary skill in the art, a lubricant is a compound that acts to reduce the frictional force between a variety of different surfaces, including the following: polymer:polymer; polymer:metal; polymer; organic material; and polymer:inorganic material. Specific examples of lubricating agents or lubricants as described herein are compounds comprising silo functional groups, including siloxanes and polysiloxanes, and fatty acid salts, including metal stearates.

Compounds comprising two or more, three or more, four or more, five or more, six or more, seven or more, eight or more, nine or more, or ten or more siloxy groups can be used as the lubricant described herein. Siloxanes, as understood by those in the art, are a class of molecules with a backbone of alternating silicon atom (Si) and oxygen (O) atoms, each silicon atom can have a connecting hydrogen (H) or a saturated or unsaturated organic group, such as —CH3 or C2H5. Polysiloxanes are a polymerized siloxanes, usually having a higher molecular weight. In some embodiments described herein, the polysiloxanes can be high molecular weight, such as ultra-high molecular weight polysiloxanes. In some embodiments, high and ultra-high molecular weight polysiloxanes can have weight average molecular weights ranging from 500,000 to 1,000,000.

A fatty acid salt described herein can be any fatty acid salt not inconsistent with the objectives of this disclosure. In some instances, a fatty acid salt can be any fatty acid salt that acts as a lubricant. The fatty acid of the fatty acid salt can be a fatty acid having between 12 to 22 carbon atoms. For example, the metal fatty acid can be selected from the group consisting of: Lauric acid, myristic acid, palmitic acid, stearic acid, oleic acid, linoleic acid, linolenic acid, palmitoleic acid, behenic acid, erucic acid, and arachidic acid. The metal can be any metal not inconsistent with the objectives of this disclosure. In some instances, the metal is an alkaline or alkaline earth metal, such as Li, Be, Na, Mg, K, Ca, Rb, Sr, Cs, Ba, Fr, and Ra. In some embodiments, the metal is Li, Be, Na, Mg, K, or Ca.

A fatty acid salt can be lithium stearate, sodium stearate, lithium oleate, sodium oleate, sodium palmitate, lithium palmitate, potassium stearate, or potassium oleate.

A lubricant, including the fatty acid salts described herein, can have a melting point of 200° C. or above, 210° C. or above, 220° C. or above, 230° C. or above, or 240° C. or above. A fatty acid salt such as lithium stearate (melting point of 220° C.) or sodium stearate (melting point 245 to 255° C.) has such a melting point.

In some embodiments, an additive can comprise one or more nucleating agents. As understood by one of ordinary skill in the art, nucleating agents are, in some embodiments, materials, inorganic materials, that assist in, increase, or enhance crystallization of polymers, including semi-crystalline polymers.

In some cases, an additive can comprise a cavitation promoter. Cavitation promoters, as understood by those skilled in the art, are materials that form, assist in formation of, increase formation of, or enhance the formation of bubbles or voids in the polymer.

An additive can comprise a fluoropolymer in some instances, such as the fluoropolymers discussed in detail herein.

In some embodiments, an additive can comprise a cross-linker.

An additive described herein can in some embodiments comprise an x-ray detectable material. An x-ray detectable material can be any x-ray detectable material not inconsistent with the objectives of this disclosure, such as, for example, those disclosed in U.S. Pat. No. 7,662,510, which is incorporated by reference herein in its entirety. Suitable amounts of the x-ray detectable material or element are also disclosed in the '510 patent, but in some embodiments, up to 50 weight %, up to 40 weight %, up to 30 weight %, up to 20 weight %, up to 10 weight %, up to 5 weight %, or up to 1 weight % based on the total weight of the porous film or substrate can be used. In an embodiment, the additive is barium sulfate.

In some embodiments, an additive can comprise a lithium halide. The lithium halide can be lithium chloride, lithium fluoride, lithium bromide, or lithium iodide. The lithium halide can be lithium iodide, which is both ionically conductive and electrically insulative. In some instances, a material that is both ionically conductive and electrically insulative can be used as part of a battery separator.

In some embodiments, an additive can comprise a polymer processing agent. As understood by those skilled in the art, polymer processing agents or additives are added to improve processing efficiency and quality of polymeric compounds. In some embodiments, the polymer processing agent can be antioxidants, stabilizers, lubricants, processing aids, nucleating agents, colorants, antistatic agents, plasticizers, or fillers.

In some embodiments, an additive can comprise high temperature melt index (HTMI) polymer. The HTMI polymer can be any HTMI polymer not inconsistent with the objectives of this disclosure. In some instances, the HTMI polymer can be at least one selected from the group consisting of PMP, PMMA, PET, PVDF, Aramid, syndiotactic polystyrene, polyimide, polyamide, and combinations thereof.

An additive can optionally comprise an electrolyte. Electrolytes as described herein can be any electrolyte not inconsistent with the objectives of this disclosure. The electrolyte can be any additive typically added by battery makers, particularly lithium battery makers to improve battery performance. Electrolytes should also be capable of being combined, such as miscible, with the polymers used for the polymeric porous substrate or compatible with the coating slurry. Miscibility of the additives can also be assisted or improved by coating or partially coating the additives. For example, exemplary electrolytes are disclosed in A Review of Electrolyte Additives for Lithium-Ion Batteries, J. of Power Sources, vol. 162, issue 2, 2006 pp. 1379-1394, which is incorporated by reference herein in its entirety. In some embodiments, the electrolyte is at least one selected from the group consisting of a solid electrolyte interphase (SEI) improving agent, a cathode protection agent, a flame retardant additive, LiPF₆ salt stabilizer, an overcharge protector, an aluminum corrosion inhibitor, a lithium deposition agent or improver, or a solvation enhancer, an aluminum corrosion inhibitor, a wetting agent, and a viscosity improver. In some embodiments, the electrolyte can have more than one property, such as it can be a wetting agent and a viscosity improver.

Exemplary SEI improving agents include VEC (vinyl ethylene carbonate), VC (vinylene carbonate), FEC (fluoroethylene carbonate), LiBOB (Lithium bis(oxalato) borate). Exemplary cathode protection agents include N,N′-dicyclohexylcarbodiimide, N,N-diethylamino trimethylsilane, LiBOB. Exemplary flame-retardant additives include TTFP (tris(2,2,2-trifluoroethyl) phosphate), fluorinated propylene carbonates, MFE (methyl nonafluorobuyl ether). Exemplary LiPF₆ salt stabilizers include LiF, TTFP (tris(2,2,2-trifluoroethyl) phosphite), 1-methyl-2-pyrrolidinone, fluorinated carbamate, hexamethyl-phosphoramide. Exemplary overcharge protectors include xylene, cyclohexylbenzene, biphenyl, 2,2-diphenylpropane, phenyl-tert-butyl carbonate. Exemplary Li deposition improvers include AlI₃, SnI₂, cetyltrimethylammonium chlorides, perfluoropolyethers, tetraalkylammonium chlorides with a long alkyl chain. Exemplary ionic salvation enhancer include 12-crown-4, TPFPB (tris(pentafluorophenyl)). Exemplary Al corrosion inhibitors include LiBOB, LiODFB, such as borate salts. Exemplary wetting agents and viscosity dilutersinclude cyclohexane and P₂O₅.

In some embodiments, the electrolyte additive is air stable or resistant to oxidation. A battery separator comprising the electrolyte additive disclosed herein can have a shelf life of weeks to months, e.g. one week to 11 months.

In some embodiments, an additive can comprise an energy dissipative non-miscible additive. Non-miscible means that the additive is not miscible with the polymer used to form the layer of the porous film or substrate that contains the additive.

As previously discussed, a substrate described herein can be MD stretched or TD stretched to make the substrate porous. In some instances, the substrate is produced by sequentially performing a TD stretch of an MD stretched substrate, or by sequentially performing an MD stretch of a TD stretched substrate. In addition to a sequential MD-TD stretching (with or without relax), the substrate can also simultaneously undergo a biaxial MD-TD stretching (with or without relax). Moreover, the simultaneous or sequential MD-TD stretched porous substrate can be followed by a subsequent stretching, reaxing, heat setting, or calendering step to reduce the substrate's thickness, reduce roughness, reduce percent porosity, increase TD tensile strength, increase uniformity, and/or reduce TD splittiness.

In some embodiments, a substrate can comprise pores having an average pore size of 0.01 nm to 1 micron, 0.01 micron to 1 micron, 0.02 micron to 1 micron, 0.03 micron to 1 micron, 0.04 micron to 1 micron, 0.05 micron to 1 micron, 0.06 micron to 1 micron, 0.07 micron to 1 micron, 0.08 micron to 1 micron, 0.09 micron to 1 micron, 0.1 micron to 1 micron, 0.2 micron to 1 micron, 0.3 micron to 1 micron, 0.4 micron to 1 micron, 0.5 micron to 1 micron, 0.6 micron to 1 micron, 0.7 micron to 1 micron, 0.8 micron to 1 micron, 0.9 micron to 1 micron, 0.01 micron to 0.9 micron, 0.01 micron to 0.8 micron, 0.01 micron to 0.7 micron, 0.01 micron to 0.6 micron, 0.01 micron to 0.5 micron, 0.01 micron to 0.4 micron, 0.01 micron to 0.3 micron, 0.01 micron to 0.2 micron, 0.01 micron to 0.1 micron, 0.01 micron to 0.09 micron, 0.01 micron to 0.08 micron, 0.01 micron to 0.07 micron, 0.01 micron to 0.06 micron, 0.01 micron to 0.05 micron, 0.01 micron to 0.04 micron, 0.01 micron to 0.03 micron, 1 micron, 0.9 micron, 0.8 micron, 0.7 micron, 0.6 micron, 0.5 micron, 0.4 micron, 0.3 micron, 0.2 micron, 0.1 micron, 0.09 micron, 0.08 micron, 0.07 micron, 0.06 micron, 0.05 micron, 0.04 micron, 0.03 micron, 0.02 micron, or 0.01 micron.

In an embodiment, a porous substrate can be manufactured using an exemplary process that includes stretching and a subsequent calendering step such as a machine direction stretching followed by transverse direction stretching (with or without machine direction relax) and a subsequent calendering step as a method of reducing the thickness of such a stretched substrate, for example, a multilayer porous substrate, in a controlled manner, to reduce the percent porosity of such a stretched substrate, for example, a multilayer porous substrate, in a controlled manner, and/or to improve the strength, properties, and/or performance of such a stretched substrate, for example, a multilayer porous substrate, in a controlled manner, such as the puncture strength, machine direction and/or transverse direction tensile strength, uniformity, wettability, coatability, runnability, compression, spring back, tortuosity, permeability, thickness, pin removal force, mechanical strength, surface roughness, hot tip hole propagation, and/or combinations thereof, of such a stretched substrate, for example, a multilayer porous substrate, in a controlled manner, and/or to produce a unique structure, pore structure, material, substrate, base substrate, and/or separator.

In some instances, the TD tensile strength of the multilayer substrate can be further improved by the addition of a calendering step following TD stretching. The calendering process typically involves heat and pressure that can reduce the thickness of a porous substrate. The calendering process step can recover the loss of MD and TD tensile strength caused by TD stretching. Furthermore, the increase observed in MD and TD tensile strength with calendering can create a more balanced ratio of MD and TD tensile strength which can be beneficial to the overall mechanical performance of the multilayer substrate.

The calendering process can use uniform or non-uniform heat, pressure and/or speed to selectively densify a heat sensitive material, to provide a uniform or non-uniform calender condition (such as by use of a smooth roll, rough roll, patterned roll, micro pattern roll, nano pattern roll, speed change, temperature change, pressure change, humidity change, double roll step, multiple roll step, or combinations thereof), to produce improved, desired or unique structures, characteristics, and/or performance, to produce or control the resultant structures, characteristics, and/or performance, and/or the like. In an embodiment, a calendering temperature of 50° C. to 70° C. and a line speed of 40 to 80 ft/min can be used, with a calendering pressure of 50 to 200 psi. The higher pressure can in some instances provide a thinner separator, and the lower pressure provide a thicker separator.

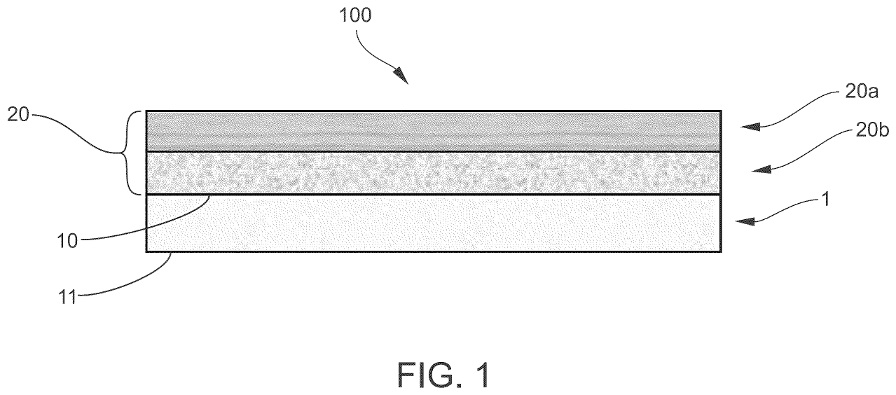

In some embodiments, a porous substrate or membrane described herein can comprise a coating positioned on the first surface, on the second surface, or on both the first and second surfaces of the porous substrate. As shown in FIG. 1 or FIG. 1 of the drawings, a separator or coated separator or coated membrane 100 comprises a substrate 1 with the first surface 10 of substrate 1 facing an opposite direction than the second surface 11. In some embodiments, the coating can comprise a first layer and a second layer. In some instances, the first layer of the coating can be positioned on the first surface of the substrate, on the second surface of the substrate, or on both the first and second surfaces of the substrate. When the first layer is positioned on the first and/or second surfaces of the substrate, the second layer of the coating can be positioned over one or both of the first layer(s) of the coating.

In some embodiments, the second layer of the coating can be positioned on the first surface of the substrate, on the second surface of the substrate, or on both the first and second surfaces of the substrate. When the second layer is positioned on the first and/or second surfaces of the substrate, the first layer of the coating can be positioned over one or both of the second layer of the coating.

In further embodiments, the first layer of the coating can be positioned on one of the first surface or second surface of the substrate, and the second layer of the coating can be positioned on the other of the first surface or second surface of the substrate. In this embodiment, the first layer on one of the surfaces of the substrate can optionally be covered with the second layer, and the second layer on the other of the surfaces of the substrate can optionally covered with the first coating, such that the first and second surfaces a have an opposite configuration of coating layers.

Further still, in other embodiments, the first layer can be positioned on both the first and second surfaces of the substrate, and only one of the two first layers on the substrate is additionally covered with a second layer of the coating. Similarly, in other instances, the second layer can be positioned on both the first and second surfaces of the substrate, and only one of the two second layers on the substrate is additionally covered with the first layer of the coating.

The first layer and the second layer can each have any thickness not inconsistent with the objectives of this disclosure. In some cases, the first layer has a thickness of 100 nm to 20 microns, 500 nm to 15 microns, 500 nm to 10 microns, 500 nm to 5 microns, or 500 nm to 1 micron The second layer can have a thickness of 500 nm to 20 microns, 500 nm to 15 microns, 500 nm to 10 microns, 500 nm to 5 microns, or 500 nm to 1 micron. The thickness of the first and second layers may be the same or different.

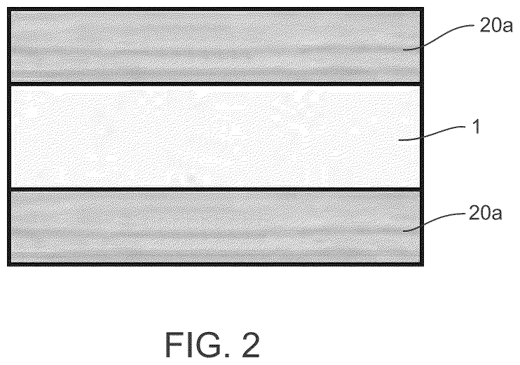

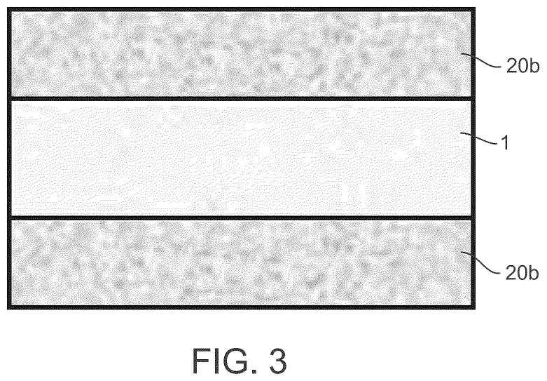

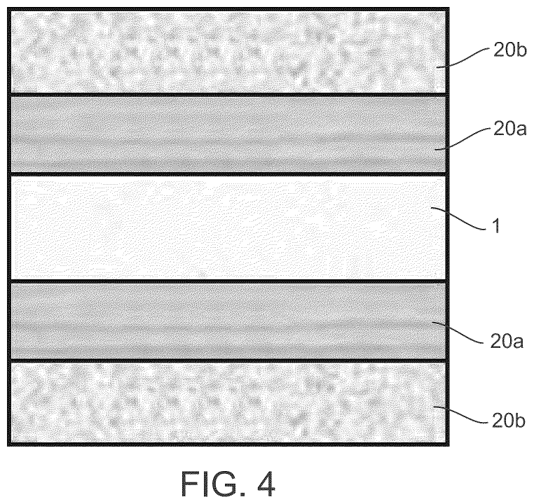

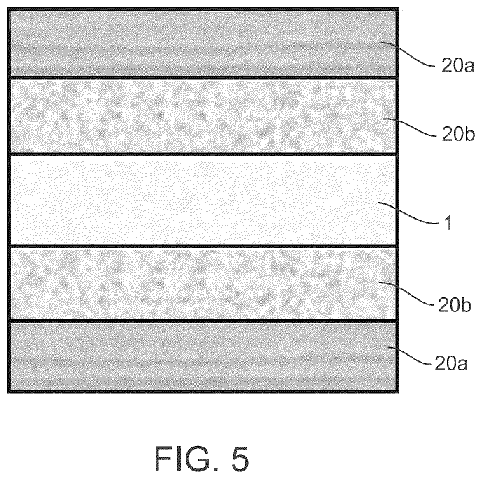

FIGS. 1-10 illustrate the different combinations in which the first and second layers can be positioned on a substrate described herein. For FIGS. 1-10, a substrate 1 described herein has a first surface 10 and an opposite facing second surface 11. A coating 20 described herein can be positioned on the first surface 10, on the second surface 11, or on both the first and second surfaces 10,11 of the substrate 1. The coating 20 can comprise a first layer 20a, a second layer 20b, or, as shown in FIG. 1, both a first and second layer 20a. In FIG. 1, an exemplary coating 20 is positioned on a first surface 10 of a substrate. The second layer 20b is positioned directly on the first surface 10, and the first layer 20a is positioned over the second layer 20b. This general arrangement is merely exemplary, and in other embodiments, the first layer 20a can be positioned directly on the first surface 10, and the second layer 20b can be positioned over the first layer 20a. FIG. 2 shows an exemplary separator embodiment where a first layer 20a is positioned on both the first and second surfaces of the substrate 1. Again, while the first layer 20a is positioned on both the first and second surfaces of the substrate 1, in some embodiments, the first layer 20a is positioned on only one of the first and second surfaces. FIG. 3 shows an exemplary separator embodiment where a second layer 20b is positioned on both the first and second surfaces of the substrate 1. In some instances, the second layer 20b is positioned on only one of the first and second surfaces of the substrate. FIG. 4 shows an embodiment where a first layer 20a is positioned on both the first and second surfaces of the substrate 1, and a second layer 20b is positioned over each of the first layers 20a. Thus, in the embodiment of FIG. 4, the first layer 20a is encapsulated or disposed between the substrate 1 and the second layer 20b. FIG. 5 shows an embodiment where a second layer 20b is positioned on both the first and second surfaces of the substrate 1, and a first layer 20a is positioned over each of the second layers 20b. Thus, in the embodiment of FIG. 5, the second layer 20b is encapsulated or disposed between the substrate 1 and the first layer 20a.

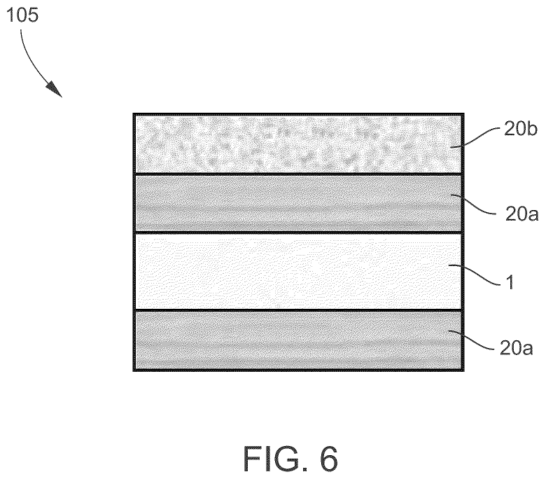

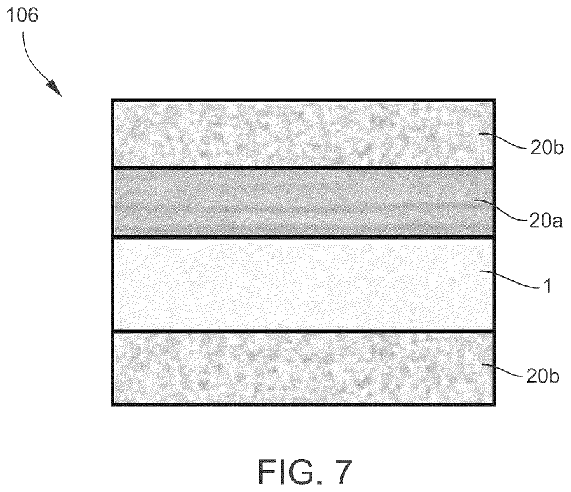

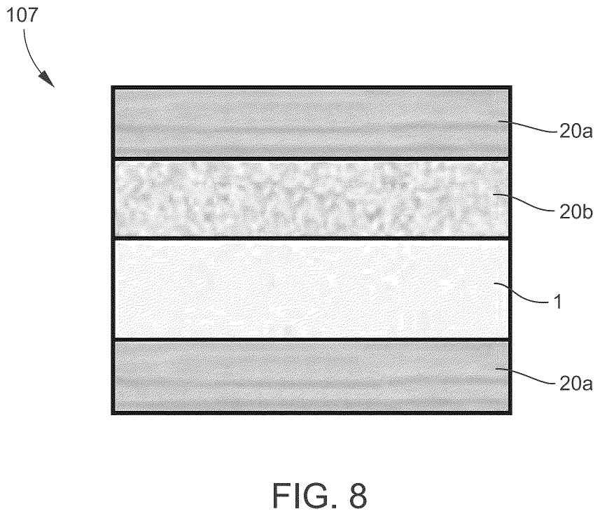

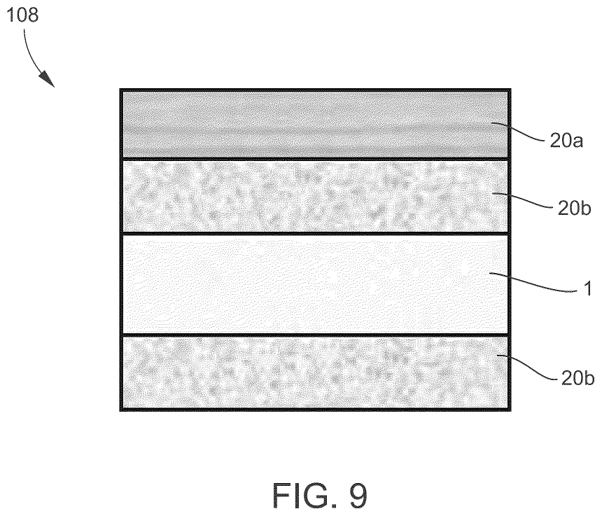

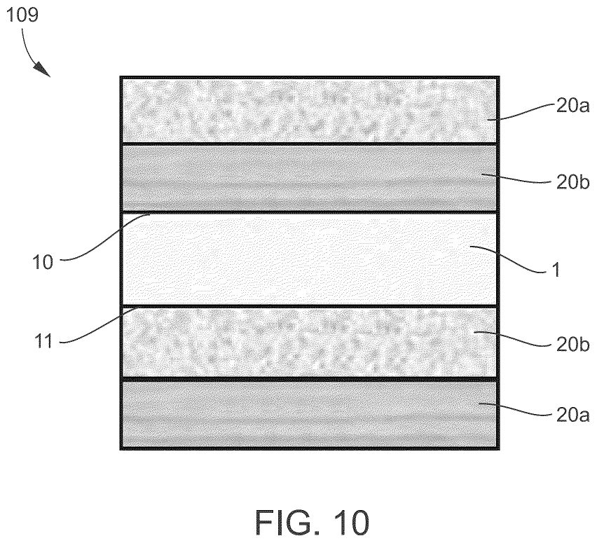

In some embodiments, a separator described here can comprise a substrate having different first and second layer combinations on the first and second sides. For instance, as shown in FIG. 6, in some embodiments a separator 105 can comprise a first layer 20a positioned on one surface of the substrate and is covered with a second layer 20b, and another first layer 20a positioned on the opposite surface of the substrate 1. In FIG. 7, a separator 106 comprises a first layer 20a positioned on one surface of the substrate and is covered with a second layer 20b, and another second layer 20b positioned on the opposite surface of the substrate 1. FIG. 8 shows an embodiment where a separator 107 comprises a second layer 20b positioned on one surface of the substrate and is covered with a first layer 20a, and a first layer 20a positioned on the opposite surface of the substrate 1. FIG. 9 shows an embodiment where a separator 108 comprises a second layer 20b positioned on one surface of the substrate that is covered with a first layer 20a, and a second layer 20a positioned on the opposite surface of the substrate 1. In the embodiment shown in FIG. 10, a separator 109 comprises first layer 20a is positioned on a first surface 10 of a substrate 1, and a second layer 20b is positioned over the first layer 20a. Additionally for FIG. 10, a second layer 20b is positioned on a second surface 11 of the substrate 1, and a first layer 20a is positioned over the second layer 20b.

In some embodiments, a first layer 20a described herein can have a first density, and a second layer 20b described herein can have a second density. In some instances, the first density is different from the second density. In some instances, a first layer can have a density of 0.1 g/cm³ to 1.3 g/cm³, 0.1 g/cm³ to 1 g/cm³, 0.1 g/cm³ to 0.8 g/cm³, 0.1 g/cm³ to 0.5 g/cm³, 0.5 g/cm³ to 1.3 g/cm³, 0.8 g/cm³ to 1.3 g/cm³, 1 g/cm³ to 1.3 g/cm³, up to 0.5 g/cm³, up to 0.8 g/cm³, or up to 1.3 g/cm³. In some instances, a second layer can have a density of 1.3 g/cm³ to 3 g/cm³, 1.8 g/cm³ to 3 g/cm³, 2 g/cm³ to 3 g/cm³, 2.5 g/cm³ to 3 g/cm³, 1.3 g/cm³ to 2.5 g/cm³, 1.3 g/cm³ to 2 g/cm³, 1.3 g/cm³ to 1.8 g/cm³, at least 1.3 g/cm³, at least 1.8 g/cm³, at least 2 g/cm³, or at least 2.5 g/cm³. In a preferred embodiment, a first layer described herein comprises a density of up to 1.3 g/cm³, and a second layer described herein comprises a density of at least 1.3 g/cm³.

In instances where a first layer covers a second layer, the first layer can cover at least 30%, 40%, 50%, 60%, at least 70%, or at least 80% of the second layer. In one embodiment, a first layer forms a continuous layer over the second layer of at least 90% coverage. In instances where a second layer covers a first layer, the second layer can cover at least 60%, at least 70%, or at least 80% of the first layer. In one embodiment, a second layer forms a continuous layer over the first layer of at least 90% coverage.

In an embodiment, a first layer described herein can comprise at least 50 wt. %, at least 60 wt. %, at least 70 wt. %, at least 80 wt %, at least 90 wt. %, 95 wt. % or greater, 50-100 wt. %, 60-100 wt. %, 70-100 wt. %, 80-100 wt. %, 90-100 wt. %, 50-90 wt. %, 50-80 wt. %, 50-70 wt. %, 50-60 wt. %, or 60-80 wt. % of an organic component. An organic component can comprise methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylbutyl (meth)acrylate, 2-ethylhexyl (meth)acrylate, n-octyl (meth)acrylate, isooctyl (meth)acrylate, isononyl (meth)acrylate, lauryl (meth)acrylate, tetradecyl (meth)acrylate, polyvinylidene difluoride (PVDF), poly(vinylidene fluoride-co-hexafluoropropylene) (PVDF:HFP), polytetrafluoroethylene (PTFE), polyethylene oxide (PEO), poly(vinyl alcohol) (PVA), polyacrylonitrile (PAN), polyacrylamide, polyvinylacetate, polyvinylpyrrolidone, polytetraethylnene glycol diacrylate, a polypropylene (PP) including isotactic PP, high density PP, ultrahigh molecular weight PP, low density PP, a polyethylene (PE) including high density PE, ultrahigh molecular weight PE, low density PE, polyvinyl acetate, polyvinyl chloride, bisphenol-A polycarbonate (BPA-PC), cyclo-olefinic copolymer (COC), a polysulfone (PSF), polyether imide (PEI), polyurethane, acrylonitrile butadiene styrene (ABS), polyimide, polyamide, copolymers of any of the foregoing, or any combination thereof.

As described herein, an organic component can, in some cases, be a “sticky” component, either alone or after having been combined with a solvent or electrolytic liquid. Thus, a first layer described herein can have a “sticky” or “tacky” texture or surface. In some cases, the organic component serves as a binder or adhesive to hold and/or immobilize other components of a coating on a surface of a separator. An organic component described herein can also be characterized as a gel-forming polymer, where the gel is formed when contacted with a liquid, such as an electrolyte solution.

A first layer described herein can, in some cases further comprise an inorganic component, the inorganic component being 50 wt. % or less, 25 wt % or less, 15 wt. % or less, 5 wt. % or less, 0.5 wt. % based on the total weight of the first layer. An inorganic component described herein can comprise a ceramic, a metal oxide, a metal hydroxide, a metal carbonate, a silicate, kaolin, talc, a mineral, a glass, or any combination thereof. In some embodiments, an inorganic composition described herein can comprise aluminum oxide (Al₂O₃), boehmite (Al(O)(OH)), titanium oxide (TiO₂), silicon oxide (SiO₂), zinc oxide (ZnO₂), zirconium dioxide (ZrO₂), barium sulfate (BaSO₄), barium titanium oxide (BaTiO₃), aluminum nitride, silicon nitride, calcium fluoride, barium fluoride, zeolite, apatite, kaoline, mullite, spinel, olivine, mica, tin dioxide (SnO₂), indium tin oxide, an oxide of a transition metal, or any combination thereof.

A second layer described herein can comprise 50-100 wt. %, 50-90 wt. %, 50-80 wt. %, 50-70 wt. %, 50-60 wt. %, 60-100 wt. %, 70-100 wt. %, 80-100 wt. %, 90-100 wt. %, or at least 50 wt. % of an inorganic component based on the total weight of the second layer, the inorganic component being previously described herein. In some embodiments, the second layer can further comprise an organic component previously described herein, the organic component being 49% or less, 40 wt. % or less, 30 wt. % or less, 20 wt. % or less, 10 wt. % or less, 5 wt. % or less, or less than 3 wt. %, based on the total weight of the second layer.

In some embodiments, a first layer and a second layer of a coating described herein have a different average porosity than the other layer. In some instances, a first layer and a second layer of a coating described herein can have a similar or the same average porosity. For example, a first layer described herein can have an average porosity of up to 50%, up to 45%, up to 40%, up to 35%, up to 30%, up to 25%, up to 20%, up to 15%, up to 10%, or up to 5%. A second layer described herein can have an average porosity of up to 50%, up to 45%, up to 40%, up to 35%, up to 30%, up to 25%, up to 20%, up to 15%, up to 10%, or up to 5%. In some particularly instances, a first layer and a second layer of the coating have a porosity of up to 10% by volume.

### II. Method of Preparing a Coated Separator

In another aspect, a method of preparing a coated separator described in Section I comprises coating a first surface, an opposite facing second surface, or both the first surface and the second surface of a porous substrate according to Section I with a first layer and a second layer, the first layer having a first density and the second layer having a second density that is different from the first density. The first layer and the second layer are described above in Section I.

### III. Battery Separator with Swelling Coating

In an aspect, a battery separator can comprise a porous substrate described in Section I having a first surface and an opposite facing second surface. A coating positioned on the first surface, on the second surface, or on both the first and second surfaces of the porous substrate, the coating comprises an inorganic component described in Section I and a polymer. In some embodiments, the polymer is an electrolyte absorbing polymer. For purposes herein, the polymer will be referred to as an “electrolyte absorbing polymer,” although, as described in more detail below, the polymer is not limited to “electrolyte absorbing” polymers. Instead, the polymer can comprise any polymer not inconsistent with the objectives of this disclosure that absorb liquids such as solvent, and swell upon absorption of such liquids.

In some cases, an electrolyte absorbing polymer has a first size when dry, and a second size when the electrolyte absorbing polymer is contacted with an electrolyte, the first size being smaller than the second size. The electrolyte absorbing polymer can swell from the first size to the second size upon absorption of an electrolyte, solvent, or other liquid.

In some embodiments, when a coating of an inorganic component and an electrolyte absorbing polymer is positioned on a surface of a porous substrate in a dry state, the inorganic component of the coating extends further outward and away from a first and/or second surface of the substrate than the electrolyte absorbing polymer when the electrolyte absorbing polymer is the first size. In this dry state, the inorganic component can in some cases improve handlability of the porous substrate, by protecting the electrolyte absorbing polymer from being contacted during manufacture or assembly of the battery separator into a battery or device. The electrolyte absorbing polymer can have a “sticky” or adhesive-like property that can pick up and adhere undesirable contaminants, so the larger inorganic components can block or hinder access of the contaminants to the electrolyte absorbing polymer. However, when the battery separator is in an assembled state in a battery, exposure of the inorganic component to electrolyte or electrodes is undesirable. Therefore, in instances where the electrolyte absorbing polymer contacts electrolyte or other liquids, the electrolyte absorbing polymer can absorb the electrolyte or liquid and swell to a second size in a wet state. In some embodiments, an electrolyte absorbing polymer extends further outward from a first and/or second surfaces of a porous substrate than an inorganic component when the electrolyte absorbing polymer is a second size, the second size being formed when the electrolyte absorbing polymer has absorbed electrolyte or liquid. In the wet state, the second sized electrolyte absorbing polymer can form a “sticky” or adhesive-like coating on the separator, which, in some cases, can be advantageous. For instance, the stickiness of the coating can assist or improve adherence of the separator to different components in a battery, such as an electrode.

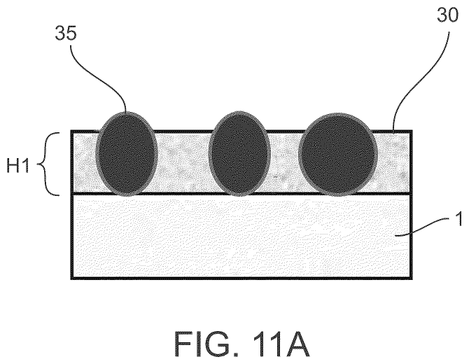

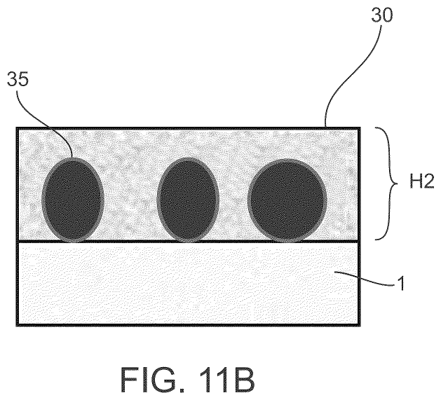

When the electrolyte absorbing polymer is in a wet state and is the second size, the inorganic component can be encapsulated between the porous substrate and the electrolyte absorbing polymer. FIGS. 11A and 11B illustrate a porous substrate 1 having a coating on one surface of the substrate 1. The coating comprises an electrolyte absorbing polymer 30 and an inorganic component 35. As shown in FIG. 11A, when the electrolyte absorbing polymer 30 is in a dry state, the electrolyte absorbing polymer 30 has a first size, indicated by “H1”. When the electrolyte absorbing polymer 30 is the first size H1, the inorganic components 35 extend further outward from surface of the substrate 1. Thus, the inorganic components 35 have a size that is greater than or equal to H1. In FIG. 11B, the electrolyte absorbing polymer 30 is in a wet state, having absorbed an electrolyte or liquid. In the wet state, the electrolyte absorbing polymer 30 has swelled and has a thickness of the second size H2. In this example, the electrolyte absorbing polymer 30 extends further outward form the surface of the substrate 1, and the inorganic components 35 are covered/encapsulated within and/or between the electrolyte absorbing polymer 30 and the substrate 1. Stated differently, the inorganic components have a height, thickness, or diameter that is less that the thickness of the second size H2. Notably, while FIGS. 11A and 11B show a separator 1 having a single surface coated, the battery separator is not limited to this arrangement. Rather, in some embodiments, the battery separator can be coated on both the first and second surfaces. Moreover, in instances of both surfaces being coated, the inorganic components and/or electrolyte absorbing polymers can be of the same type, or can be of a different type for each surface.

An inorganic component described in this section can comprise a ceramic, a metal oxide, a metal hydroxide, a metal carbonate, a silicate, kaolin, talc, a mineral, a glass, or any combination thereof. In some embodiments, an inorganic component described in this section can comprise aluminum oxide (Al₂O₃), boehmite (Al(O)(OH)), titanium oxide (TiO₂), silicon oxide (SiO₂), zinc oxide (ZnO₂), zirconium dioxide (ZrO₂), barium sulfate (BaSO₄), barium titanium oxide (BaTiO₃), aluminum nitride, silicon nitride, calcium fluoride, barium fluoride, zeolite, apatite, kaoline, mullite, spinel, olivine, mica, tin dioxide (SnO₂), indium tin oxide, an oxide of a transition metal, or any combination thereof.

An electrolyte absorbing polymer described in this section can comprise methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylbutyl (meth)acrylate, 2-ethylhexyl (meth)acrylate, n-octyl (meth)acrylate, isooctyl (meth)acrylate, isononyl (meth)acrylate, lauryl (meth)acrylate, tetradecyl (meth)acrylate, polyvinylidene difluoride (PVDF), poly(vinylidene fluoride-co-hexafluoropropylene) (PVDF:HFP), polytetrafluoroethylene (PTFE), polyethylene oxide (PEO), poly(vinyl alcohol) (PVA), polyacrylonitrile (PAN), polyacrylamide, polyvinylacetate, polyvinylpyrrolidone, polytetraethylnene glycol diacrylate, a polypropylene (PP) including isotactic PP, high density PP, ultrahigh molecular weight PP, low density PP, a polyethylene (PE) including high density PE, ultrahigh molecular weight PE, low density PE, polyvinyl acetate, polyvinyl chloride, bisphenol-A polycarbonate (BPA-PC), cyclo-olefinic copolymer (COC), a polysulfone (PSF), polyether imide (PEI), polyurethane, acrylonitrile butadiene styrene (ABS), polyimide, polyamide, copolymers of any of the foregoing, or any combination thereof.

### IV. Self-Defense Battery Separator

In another aspect, a battery separator can comprise a porous substrate described in Section I, the porous substrate having a first surface and an opposite facing second surface. A coating is positioned on the first surface, on the second surface, or on both the first and second surfaces of the porous substrate, and the coating comprises an electrolyte absorbing material.

An electrolyte absorbing material can comprise any electrolyte absorbing material not inconsistent with the objectives of this disclosure. In some embodiments, an electrolyte absorbing material can comprise aluminum oxide (Al₂O₃), boehmite (Al(O)(OH)), titanium oxide (TiO₂), silicon oxide (SiO₂), zinc oxide (ZnO₂), zirconium dioxide (ZrO₂), barium sulfate (BaSO₄), barium titanium oxide (BaTiO₃), aluminum nitride, silicon nitride, calcium fluoride, barium fluoride, zeolite, apatite, kaoline, mullite, spinel, olivine, mica, tin dioxide (SnO₂), indium tin oxide, an oxide of a transition metal, a ceramic, a metal oxide, a metal hydroxide, a metal carbonate, a silicate, kaolin, talc, a mineral, a glass, or any combination thereof.

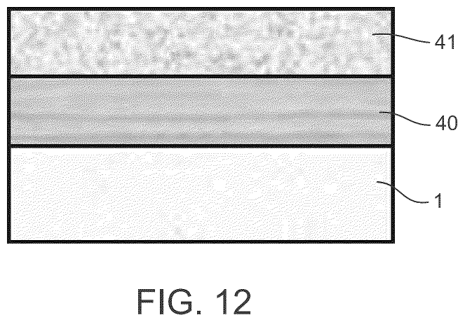

A coating described herein can further comprise a first thermally activated polymer positioned over the electrolyte absorbing material. In some embodiments, the electrolyte absorbing material is sandwiched, covered, and/or encapsulated between the first thermally activated polymer and the porous substrate. FIG. 12 illustrates this embodiment, where an electrolyte absorbing material 40 is sandwiched, covered, and/or encapsulated between a first thermally activated polymer 41 and a substrate 1.

The first thermally activated polymer layer can have any thickness not inconsistent with the objectives of this disclosure. In some instances, the first thermally activated polymer layer has a thickness of 100 nm to 20 microns, 500 nm to 15 microns, 500 nm to 10 microns, 500 nm to 5 microns, 500 nm to 4 microns, 500 nm to 3 microns, 500nm to 2 microns, or 500 nm to 1 micron.

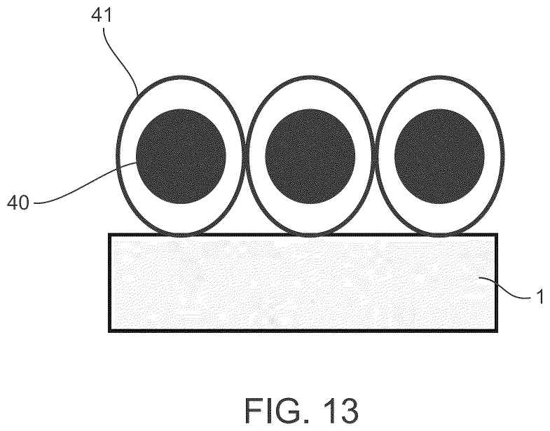

In some embodiments, an electrolyte absorbing material is substantially encapsulated inside a plurality of polymer microcapsules, the microcapsules comprising a first thermally activated polymer. FIG. 13 illustrates this embodiment, where an electrolyte absorbing material 40 is substantially encapsulated inside a plurality of polymer microcapsules 41.

In an event of a thermal runaway in a battery, where the temperature of the battery environment reaches or exceeds the melting point of the first thermally activated polymer, the covered or microencapsulated electrolyte absorbing material can become exposed and/or uncovered upon melting of the first thermally activated polymer. As is known in the art, “runaway temperatures” can vary based on conditions and the specific construction of the battery; exemplary runaway temperatures are within the range of about 120-220° C. and can be determined or estimated by experimentation or reaction modeling, if desired. Upon exposure, the electrolyte absorbing material can contact electrolyte present in the battery, and absorb the electrolyte. By absorbing the electrolyte, the battery structure is disrupted and charge transfer between the battery electrodes are severed, terminating the thermal runaway event. The first thermally activated polymer therefore can be formed from a polymer having a melting point lower than a temperature associated with thermal runaway of a battery.

A first thermally activated polymer can comprise methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylbutyl (meth)acrylate, 2-ethylhexyl (meth)acrylate, n-octyl (meth)acrylate, isooctyl (meth)acrylate, isononyl (meth)acrylate, lauryl (meth)acrylate, tetradecyl (meth)acrylate, polyvinylidene difluoride (PVDF), poly(vinylidene fluoride-co-hexafluoropropylene) (PVDF:HFP), polytetrafluoroethylene (PTFE), polyethylene oxide (PEO), poly(vinyl alcohol) (PVA), polyacrylonitrile (PAN), polyacrylamide, polyvinylacetate, polyvinylpyrrolidone, polytetraethylnene glycol diacrylate, a polypropylene (PP) including isotactic PP, high density PP, ultrahigh molecular weight PP, low density PP, a polyethylene (PE) including high density PE, ultrahigh molecular weight PE, low density PE, polyvinyl acetate, polyvinyl chloride, bisphenol-A polycarbonate (BPA-PC), cyclo-olefinic copolymer (COC), a polysulfone (PSF), polyether imide (PEI), polyurethane, acrylonitrile butadiene styrene (ABS), polyimide, polyamide, copolymers of any of the foregoing, or any combination thereof.

In some embodiments, a first thermally activated polymer described herein has a melting point of 80° C. to 200° C., 100° C. to 200° C., 120° C. to 200° C., 140° C. to 200° C., 160° C. to 200° C., 180° C. to 200° C., 80° C. to 180° C., 80° C. to 160° C., 80° C. to 140° C., 80° C. to 120° C., 80° C. to 100° C., 100° C. to 180° C., 100° C. to 160° C., or 100° C. to 140° C.

A battery environment, as used herein, can be an environment with a battery itself, or can be a simulate battery environment.

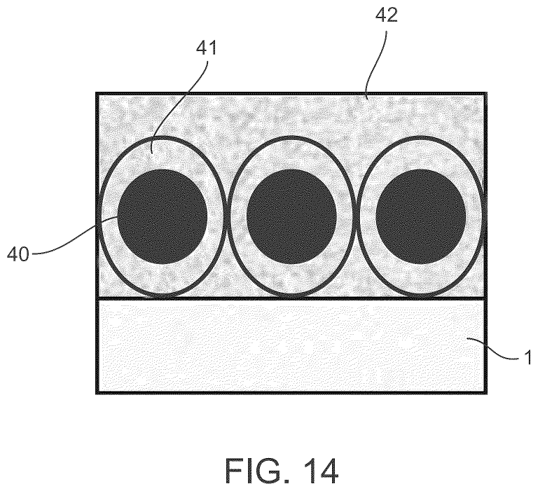

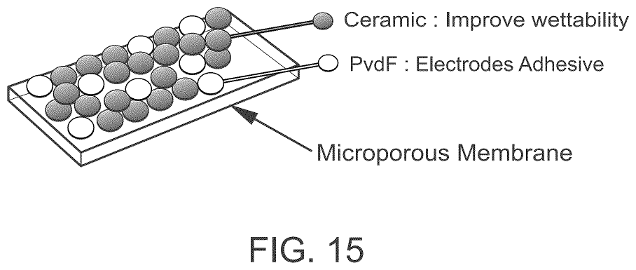

In another embodiment, a coating described herein can further comprise a second thermally activated polymer covering the layer of microencapsulated electrolyte absorbing material. FIG. 14 illustrates this embodiment, where a second thermally activated polymer 42 is covers a layer of electrolyte absorbing material 40 microencapsulated in a first thermally activated polymer 41.

The second thermally activated polymer layer can have any thickness not inconsistent with the objectives of this disclosure. In some instances, the second thermally activated polymer layer has a thickness of 500 nm to 20 microns, 500 nm to 15 microns, 500 nm to 10 microns, 500 nm to 5 microns, 500 nm to 4 microns, 500 nm to 3 microns, 500nm to 2 microns, or 500 nm to 1 micron.

A second thermally activated polymer can the same composition or a different composition as the first thermally activated polymer. In some embodiments, a second thermally activated polymer comprises methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylbutyl (meth)acrylate, 2-ethylhexyl (meth)acrylate, n-octyl (meth)acrylate, isooctyl (meth)acrylate, isononyl (meth)acrylate, lauryl (meth)acrylate, tetradecyl (meth)acrylate, polyvinylidene difluoride (PVDF), poly(vinylidene fluoride-co-hexafluoropropylene) (PVDF:HFP), polytetrafluoroethylene (PTFE), polyethylene oxide (PEO), poly(vinyl alcohol) (PVA), polyacrylonitrile (PAN), polyacrylamide, polyvinylacetate, polyvinylpyrrolidone, polytetraethylnene glycol diacrylate, a polypropylene (PP) including isotactic PP, high density PP, ultrahigh molecular weight PP, low density PP, a polyethylene (PE) including high density PE, ultrahigh molecular weight PE, low density PE, polyvinyl acetate, polyvinyl chloride, bisphenol-A polycarbonate (BPA-PC), cyclo-olefinic copolymer (COC), a polysulfone (PSF), polyether imide (PEI), polyurethane, acrylonitrile butadiene styrene (ABS), polyimide, polyamide, copolymers of any of the foregoing, or any combination thereof.

In some embodiments, a second thermally activated polymer described herein has a melting point of 150° C. to 200° C., 160° C. to 200° C., 170° C. to 200° C., 180° C. to 200° C., 190° C. to 200° C., 150° C. to 190° C., 150° C. to 180° C., 150° C. to 170° C., 150° C. to 160° C., 160° C. to 180° C., at least 150° C., or 150° C. or greater.

In one embodiment, a first thermally activated polymer described herein has a melting point of 80° C. to 200° C., and a second thermally activated polymer described herein has a melting point of 150° C. to 200° C.

When the first thermally activated polymer is heated to a temperature at or above its melting point, the first thermally activated polymer can melt and expose the electrolyte absorbing material and the second thermally activated polymer. In some cases, the electrolyte absorbing material is then exposed to electrolyte, and subsequently absorbs the electrolyte to disrupt charge transfer between the electrodes of the battery. In some instances, the battery separator is exposed to heat sufficient to melt the first and second thermally activated polymers. In these cases, the battery separator can self-heal, where the second thermally activated polymer melts and encapsulates the electrolyte absorbing material of the first layer upon exposure to heat sufficient to melt the first thermally activated polymer. Thus, prior to a thermal event, coatings described herein contain electrolyte absorbing material, such as particles, that are locked or sealed (i.e., not exposed) in the coating. When the thermal event occurs, the electrolyte absorbing material is unlocked or unsealed, allowing exposure of the material to the electrolyte.

### V. Method of Battery Self-Defense

In another aspect, a method of battery self-defense to thermal event is described herein. In some instances, a method of battery self-defense to a thermal event comprises melting, in a battery environment, a first thermally activated polymer in a battery separator to uncover an electrolyte absorbing material. The battery separator described in this section can be a battery separator described in Section IV. The uncovered electrolyte absorbing material is exposed to an electrolyte present in the battery environment, and the method can further comprise absorbing the electrolyte with the electrolyte absorbing material after the electrolyte absorbing material is uncovered. As previously discussed in Section IV, absorption of the electrolyte disrupts the electrical connectivity between the cathode and anode of the battery, and can shut down a runaway thermal event.

In embodiments where a battery separator described in Section IV comprises a first thermally activated polymer and an electrolyte absorbing material positioned between a second thermally activated polymer and the porous substrate, the method described herein can further comprise melting the second thermally activated polymer to form an electrolyte excluding barrier on a surface of the porous substrate. In this instances, the electrolyte excluding barrier is formed by the second thermally activated polymer encapsulating at least a portion of the uncovered electrolyte absorbing material upon melting.

Various embodiments of the invention have been described in fulfillment of the various objectives of the invention. It should be recognized that these embodiments are merely illustrative of the principles of the invention. Numerous modifications and adaptations thereof will be readily apparent to those skilled in the art without departing from the spirit and scope of the invention.

### VI. Composite, Vehicle, or Device

A composite, jelly roll, pancake, or system is described herein comprising any separator as described hereinabove and one or more electrodes, e.g., an anode, a cathode, or an anode and a cathode, where the separator is provided in direct contact therewith. The specific type of electrode can be any electrode type not inconsistent with the objectives of this disclosure. For example, the electrodes can be those suitable for use in a lithium ion secondary battery.

A suitable anode can be any anode and can preferably have an energy capacity greater than or equal to preferably 372 mAh/g, preferably ≥700 mAh/g, and most preferably ≥1000 mAH/g. The anode can be constructed from a lithium metal foil or a lithium alloy foil (e.g. lithium aluminum alloys), or a mixture of a lithium metal and/or lithium alloy and materials such as carbon (e.g. coke, graphite), nickel, copper.

A suitable cathode can be any cathode compatible with the anode and can include an intercalation compound, an insertion compound, or an electrochemically active polymer. Suitable intercalation materials includes, for example, MoS₂, FeS₂, MnO₂, TiS₂, NbSe₃, LiCoO₂, LiNiO₂, LiMn₂O₄, V₆O₁₃, V₂O₅, and CuCl₂. Suitable polymers include, for example, polyacetylene, polypyrrole, polyaniline, and polythiopene.

The electrolyte can be a liquid (organic or inorganic), a gel, or a polymer. Typically, the electrolyte primarily consists of a salt and a medium (e.g. in a liquid electrolyte, the medium can be referred to as a solvent; in a gel electrolyte, the medium can be a polymer matrix). The salt can be a lithium salt. The lithium salt can include, for example, LiPF₆, LiAsF₆, LiCF₃SO₃, LiN(CF₃SO₃)₃, LiBF₆, and LiClO₄, BETTE electrolyte (commercially available from 3M Corp. of Minneapolis, MN) and combinations thereof. Solvents can include, for example, ethylene carbonate (EC), propylene carbonate (PC), EC/PC, 2-MeTHF (2-methyltetrahydrofuran)/EC/PC, EC/DMC (dimethyl carbonate), EC/DME (dimethyl ethane), EC/DEC (diethyl carbonate), EC/EMC (ethylmethyl carbonate), EC/EMC/DMC/DEC, EC/EMC/DMC/DEC/PE, PC/DME, and DME/PC. Polymer matrices may include, for example, PVDF (polyvinylidene fluoride), PVDF:THF (PVDF:tetrahydrofuran), PVDF:CTFE (PVDF:chlorotrifluoro ethylene), PVDF:HFP (PVDF:hexafluoropropylene), PAN (polyacrylonitrile), and PEO (polyethylene oxide).

Any separator and battery or cell or composite described hereinabove can be incorporated to any vehicle, e.g., an e-vehicle, or device, e.g., a cell phone or laptop, that is completely or partially battery powered.

### VII. Coated Separator 2

Also disclosed herein is a battery separator comprising a coating on one or both sides of a microporous membrane. The coating on one or both sides comprises, consists of, or consists essentially of the following: an inorganic component and at least one of a wet adhesion polymer and a dry adhesion polymer. In some preferred embodiments, the coating is on one side, and in other preferred embodiments, the coating is on both sides.

### A. Microporous Membrane

The microporous membrane of the battery separator is not so limited and any microporous membrane may be used. The term “microporous” as used herein means that the membrane has micropores having a diameter of 0.05 to 1.0 microns. In some embodiments, the microporous membrane has an average pore size or diameter of 0.01 to 1.0 microns, from 0.05 to 1.0 microns, from 0.01 to 0.9 microns, from 0.01 to 0.8 microns, from 0.01 to 0.7 microns, from 0.01 to 0.6 microns, from 0.01 to 0.5 microns, from 0.01 to 0.4 microns, from 0.01 to 0.4 microns, from 0.01 to 0.3 microns, from 0.01 to 0.2 microns, or from 0.01 to 0.1 microns.

The shape of the pores of the microporous membrane is not so limited and may be slit-shaped, elliptical, round, or substantially round. For example, round-shaped pores are disclosed in U.S. Patent Application Publication No. 2011/0223486, which is incorporated by reference herein in its entirety.

In some preferred embodiments, the microporous membrane is a microporous membrane formed by a dry-stretch process such as the Celgard® dry-stretch process. A dry-stretch process may comprise, consist of, or consist essentially of an extrusion, annealing, stretching (uniaxially or biaxially), and an optional calendering and/or pore-filling step. In some embodiments, the microporous membrane may be formed by a method comprising at least one of: a dry stretch process, a wet process (phase inversion), BNOPP, particle stretch, co-extrusion, lamination, sintering, printing, extruding, and electrospinning.

The structure of the microporous membrane is not so limited, and the structure may be a monolaer, bilayer, trilayer, or multilayer structure.

In some embodiments, the microporous membrane is a monolayer or single layer structure. A dry-process monolayer microporous membrane may be formed by extruding (monoextruding) a single nonporous monolayer precursor and stretching the precursor to form pores. In some preferred embodiments, the monolayer microporous membrane may comprise, consist of, or consist essentially of polypropylene, polyethylene, combinations of polypropylene and polyethylene, polypropylene and an additive, or polyethylene and an additive.

In some embodiments, the microporous membrane may be a bilayer structure. A dry-process bilayer microporous membrane may be formed by laminating two extruded (mono-extruded) monolayers together or by co-extruding two layers together. A bilayer may also be formed by a bubble film extrusion process where the bubble is collapsed on itself to form a bilayer. Each layer of the bilayer structure may comprise, consist of, or consist essentially of polypropylene, polyethylene, combinations of polypropylene and polyethylene, polypropylene and an additive, or polyethylene and an additive. Each layer of the bilayer may have the same composition or different compositions.

In some embodiments, the microporous membrane may have a trilayer structure. A dry-process trilayer microporous membrane may be formed by laminating three monolayers together. For example, two polypropylene-containing mono-extruded monolayers may be laminated with one polyethylene-containing mono-extruded monlayer to form a PP/PE/PP trilayer structure, or two polyethylene-containing mono-extruded monolayers may be laminated with one polypropylene containing mono-extruded monolayers to form a PE/PP/PE trilayer structure. In some embodiments, three layers may be coextruded to form a trilayer structure. For example, the coextruded trilayer may have a structure PP/PE/PP or PE/PP/PE, where PE is a polyethylene-containing coextruded layer and PP is a polypropylene-containing coextruded layer. In some other embodiments, a trilayer structure may be formed by laminating a mono-extruded monolayer with a coextruded bilayer.

In some embodiments, the microporous membrane may be a multilayer structure. For example, some exemplary multilayer structures are disclosed in U.S. Pat. No. 9,908,317 and WO/2018/089748, which are both incorporated by reference herein in their entirety.

In some embodiments, the multilayer microporous membrane or multilayer microporous film comprises 4 or more, 5 or more, 6 or more, 7 or more, 8 or more, 9 or more 11 or more, 12 or more, 13 or more, 14 or more, 15 or more, 15 or more, 16 or more 17 or more, 18 or more, 19 or more, 20 or more, 21 or more, 22 or more, 23 or more, 24 or more, 25 or more, 26 or more, 27 or more, 28 or more, 29 or more, 30 or more, 40 or more, 50 or more, 60 or more, 70 or more, 80 or more, 90 or more, or 100 or more layers. What is meant by the term “layer” includes a mono-extruded layer having a thickness from 2 to 20 microns. As understood by those skilled in the art, a mono-extruded layer is a layer that was extruded by itself, not with any other layers. Also, the layers of a co-extruded bi-layer, tri-layer, or multi-layer film are each considered to be a “layer” for purposes of determining whether a given battery separator is a multilayer battery separator. The number of layers in coextruded bi-layer will be two, the number of layers in a co-extruded tri-layer will be three, and the number of layers in a co-extruded multi-layer film will be two or more, preferably three or more. The exact number of layers in a bi-layer, tri-layer, or multi-layer co-extruded film is dictated by the die design and not necessarily the materials that are co-extruded to form the co-extruded film. For example, a co-extruded bi-, tri-, or multi-layer film may be formed using the same material to form each of the two, three, or four or more layers, and these layers will still be considered to be separate layers even though each is made of the same material. The exact number, again, will be dictated by the die design. The layers of the co-extruded bi-, tri-, or multi-layer films each have a thickness of 0.01 to 20 microns, preferably 0.1 to 5 microns, most preferably 0.1 to 3 microns, 0.1 to 2 microns, 0.1 to 1 microns, 0.01 to 0.9 microns, 0.01 to 0.8 microns, 0.01 to 0.7 microns, 0.01 to 0.6 microns, 0.01 to 0.5 microns, 0.01 to 0.4 microns, 0.01 to 0.3 microns, or 0.01 to 0.2 microns. These layers are microlayers.

In some embodiments, the multilayer microporous film or multilayer microporous membrane disclosed herein comprises two or more, or preferably three or more co-extruded layers. Co-extruded layers are layers formed by a co-extrusion process. The at least two, or preferably at least three consecutive coextruded layers may be formed by the same or separate co-extrusion processes. For example, the at least two or at least three consecutive layers may be formed by the same co-extrusion process or two or more layers may be coextruded by one process, two or layers may be coextruded by a separate process, and the two or more layers formed by the one process may be laminated to the two or more layers formed by the separate process so that combined there are four or more consecutive coextruded layers. In some preferred embodiments, the two or more, or preferably three or more co-coextruded layers are formed by the same co-extrusion process. For example, two or more, or preferably three or more, four or more, five or more, six or more, seven or more, eight or more, nine or more, ten or more, fifteen or more, twenty or more, twenty-five or more, thirty or more, thirty-five or more, forty or more, forty-five or more, fifty or more, fifty-five or more or sixty or more co-extruded layers may be formed by the same co-extrusion process. In further preferred embodiments, the extrusion process is performed by extruding two or more polymer mixtures, that may be the same or different, without a solvent. The preferred co-extrusion process is a dry process, e.g., the Celgard® dry stretch process.

In some embodiments, the multilayer microporous film or multilayer membrane described herein is made by forming a coextruded bi-layer (two coextruded layer), tri-layer (three coextruded layers), or multi-layer (two or more, preferably three or more co-extruded layers) film and then laminating the bi-layer, tri-layer, or multi-layer film to at least one, but preferably two other films. The at least one, but preferably two, other films may be a non-woven film mono-extruded films or a co-extruded films. In preferred embodiments, the other films are co-extruded films having the same number of co-extruded layers as the co-extruded bi-layer, tri-layer, or multi-layer films. For example, if a co-extruded tri-layer film is formed, the other layers are also co-extruded tri-layers.

Lamination of the bi-layer, tri-layer, or multilayer co-extruded film with at least one other mono-extruded monolayer film or a bi-layer, tri-layer, or multi-layer film may involve use of heat, pressure, or preferably heat and pressure.

The thickness of the microporous membrane is not so limited and may be from 1 to 50 microns, preferably from 5 to 30 microns, from 5 to 25 microns, from 5 to 20 microns, from 5 to 15 microns, or from 5 to 10 microns.

In some embodiments, the microporous membrane may be combined with another microporous membrane or a nonwoven, which may or may not be microporous. In the case that the nonwoven is microporous, it would be considered a microporous membrane.

### B. Coating

The coating is not so limited. In some embodiments, the coating may comprise, consist of, or consist essentially of an inorganic component and a wet adhesion polymer. In some embodiments, the coating may comprise, consist of, or consist essentially of an inorganic component and a dry adhesion polymer. Finally, in some embodiments, the coating may comprise, consist of, or consist essentially of an inorganic component, a dry adhesion polymer, and a wet adhesion polymer. In some embodiments, the coating may also further comprise, consist of, or consist essentially of a binder.

In some embodiments, the inorganic component may comprise, consist of, of consist essentially of a ceramic, a metal oxide, a metal hydroxide, a metal carbonate, a silicate, kaolin, talc, a mineral, a glass, or any combination thereof. In some embodiments, an inorganic component described in this section can comprise aluminum oxide (Al₂O₃), boehmite (Al(O)(OH)), titanium oxide (TiO₂), silicon oxide (SiO₂), zinc oxide (ZnO₂), zirconium dioxide (ZrO₂), barium sulfate (BaSO₄), barium titanium oxide (BaTiO₃), aluminum nitride, silicon nitride, calcium fluoride, barium fluoride, zeolite, apatite, kaoline, mullite, spinel, olivine, mica, tin dioxide (SnO₂), indium tin oxide, an oxide of a transition metal, or any combination thereof.

In some embodiments, the amount of inorganic component in the coating is 10% to 99.5%, preferably 20% to 99%, more preferably 80% to 99%, and most preferably 90% to 99% by weight. In some embodiment, the coating is “rich” in the inorganic component, meaning the inorganic component is added in an amount of 50% or more. Rich in inorganic component may mean that the inorganic component is present in an amount of 50% to 99%, 50 to 90%, 50 to 80%, 50 to 70%, or 50 to 60%.

A dry adhesion polymer as described herein is not so limited and is any polymer that imparts high or low tack to the coating. A high tack coating is harder to separate after being brought into contact with another surface with which a bond is formed. A lower tack coating is easier to separate and reposition after being brought into contact with another surface with which a bond is formed. Coatings with tack may be beneficial for battery separators used in stacked-type or prismatic-type battery cells. It helps prevent the separator from moving once in its proper position in the cell.

The dry adhesion polymer described herein may be characterized by its glass transition temperature. In some embodiments, the dry adhesion polymer has a glass transition temperature less than 100° C., less than 90° C., less than 80° C., less than 70° C., less than 60° C., less than 50° C., less than 40° C., less than 30° C. or less than 20° C. A minimum glass transition temperature may be 20° C., 10° C., 5° C., or 0° C. Preferably, in some embodiments, the glass transition temperature may be from 20° C. to 100° C., or from 20° C. to 70° C., or from 25° C. to 100° C.

The wet adhesion polymer as described herein is not so limited and may be any polymer that absorbs electrolyte, swells or grows in size when it absorbs electrolyte, and/or becomes gel-like when it absorbs electrolyte. The electrolyte may be any electrolyte suitable for use in a secondary battery, which may include but is not limited to electrolytes where the solvent is DEC, PC, DMC, EC, or combinations thereof. A wet adhesion polymer will also increase adhesion of the coating, when wet, to the anode or cathode of a secondary battery.

In some embodiments, the wet adhesion polymer may comprise, consist of, or consist essentially of a fluoropolymer. In some embodiments, the fluoropolymer is a PVDF co-polymer such as PVDF-HFP. The HFP content of the PVDF-HFP may preferably be 30 mol. % or less, more preferably less than 15 mol. %.

In some embodiments, the wet adhesion polymer may comprise, consist of, or consist essentially of methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylbutyl (meth)acrylate, 2-ethylhexyl (meth)acrylate, n-octyl (meth)acrylate, isooctyl (meth)acrylate, isononyl (meth)acrylate, lauryl (meth)acrylate, tetradecyl (meth)acrylate, polyvinylidene difluoride (PVDF), poly(vinylidene fluoride-co-hexafluoropropylene) (PVDF:HFP), polytetrafluoroethylene (PTFE), polyethylene oxide (PEO), poly(vinyl alcohol) (PVA), polyacrylonitrile (PAN), polyacrylamide, polyvinylacetate, polyvinylpyrrolidone, polytetraethylnene glycol diacrylate, a polypropylene (PP) including isotactic PP, high density PP, ultrahigh molecular weight PP, low density PP, a polyethylene (PE) including high density PE, ultrahigh molecular weight PE, low density PE, polyvinyl acetate, polyvinyl chloride, bisphenol-A polycarbonate (BPA-PC), cyclo-olefinic copolymer (COC), a polysulfone (PSF), polyether imide (PEI), polyurethane, acrylonitrile butadiene styrene (ABS), polyimide, polyamide, copolymers of any of the foregoing, or any combination thereof.

Use of wet adhesion polymers may be useful in a battery where adhesion to the electrodes are important.

In some embodiments, the coating may comprise between 20% to 80%, from 30% to 70%, from 40% to 60%, or from 50% to 60% of the wet adhesion polymer, the dry adhesion polymer, or a combination thereof. A coating may be rich in the wet adhesion polymer, the dry adhesion polymer, or a combination of wet adhesion polymer and the dry adhesion polymer. This means that the coating comprises 50% or more of the wet adhesion polymer, the dry adhesion polymer, or combinations thereof.

In some embodiments, the coating may comprise the following: 1) an inorganic component, a wet adhesion polymer, and a dry adhesion polymer, 2) an inorganic component and a wet adhesion polymer, or 3) an inorganic component and a dry adhesion polymer. In such embodiments, the particle size of the components may be the same or different.

In some embodiments, the coating may comprise an inorganic component and a wet adhesion polymer. In some such embodiments, the inorganic component and the wet adhesion polymer may have the same size when the coating is dry, and when the coating is wet, the wet adhesion polymer may swell and become larger than that of the inorganic component. The inorganic component does not grow or grow substantially in some embodiments. In these embodiments, the inorganic component may be exposed at the surface of the coating when it is dry, and this may allow for better handling of the separator. In this embodiment, when the separator coating is wet and the wet adhesion polymer swells in electrolyte, this will allow for adhesion of the coating to electrodes in a secondary battery. The wet adhesion polymer may become larger than the inorganic component and the inorganic component may no longer be exposed at the surface when the wet adhesion polymer swells.

In some embodiments, the coating described herein is a monolayer or bilayer coating. A monolayer coating as used herein is a coating that is one molecule thick where the molecule is at least one of a molecule of the inorganic component, the wet adhesion polymer, or the dry adhesion polymer. A bilayer as used herein, is a coating that is two molecules thick, where the molecule is at least one of a molecule of the inorganic component, the wet adhesion component, and the dry adhesion component.

In some embodiments, the coating may have a thickness of 1 micron or less or less than 500 nm. In some embodiments, the coating may be thicker than 1 micron. For example, in some embodiments, the coating may have a thickness from 1 micron to 10 microns, from 1 to 9 microns, from 1 to 8 microns, from 1 to 7 microns, from 1 to 6 microns, from 1 to 5 microns, from 1 to 4 microns, from 1 to 3 microns, or from 1 to 2 microns. One way of providing a thinner coating is by using a smaller inorganic component, wet adhesion polymer, and/or dry adhesion polymer. For example, the inorganic component, wet adhesion polymer, and/or dry adhesion polymer may have a particle size less than 1 micron, less than 900 nm, less than 800 nm, less than 700 nm, less than 600 nm, less than 500 nm, less than 400 nm, or less than 300 nm.

In some embodiments, the coating has a thickness of 1 micron, 900 nm or less, 800 nm or less, 700 nm or less, 600 nm or less, or 500 nm or less and is a monolayer or bilayer coating. One way of providing a thinner coating is by using a smaller inorganic component, wet adhesion polymer, and/or dry adhesion polymer. For example, the inorganic component, wet adhesion polymer, and/or dry adhesion polymer may have a particle size less than 1 micron, less than 900 nm, less than 800 nm, less than 700 nm, less than 600 nm, less than 500 nm, less than 400 nm, or less than 300 nm.

In some embodiments, the coating may be porous or non-porous as long as it is ionically conductive at normal battery operating temperatures during battery use (when wet with electrolyte). For example, a PVDF coating may be non-porous (have a high Gurley when dry) and may still be ionically conductive when wet with electrolyte during battery use. Also, very thin, ultra-thin, nano-thin coatings may be non-porous yet ionically conductive in electrolyte. A porous or microporous coating having a thickness of 1 micron or less or less than 500 nm may be preferred.

In some embodiments, the coating has enhanced electrolyte wettability compared to prior ceramic coatings and polymer coatings used on battery separators. In some embodiments, the contact angle (a measure of electrolyte wettability) of the coating is less than 35°, less than about 30°, or less than about 25°. In some embodiments, about 30° would include contact angles from 28° to 32®. In some embodiments, about 25° would include contact angles from 23° to 27°.

In some embodiments, the coating described herein has a wet adhesion of greater than 30 N/m, greater than 40 N/m, or greater than 50 N/m. In some embodiments, a coating described herein has a dry adhesion greater than 10 N/m, greater than 15 N/m, or greater than 20 N/m. In some embodiments, the coating has a wet adhesion greater than 30N/m, greater than 40 N/m, or greater than 50 N/m, and a dry adhesion greater than 10 N/m, greater than 15 N/m, or greater than 20 N/m.

In some embodiments, the coating described herein exhibits enhanced electrolyte absorption compared to prior ceramic coatings used on battery separators. For example, the coating may exhibit an electrolyte absorption of more than 2 g/sample after 60 minutes soaking in electrolyte.

### VIII. Coated Separator 3

Also disclosed herein is a battery separator comprising a coating on one or both sides of a microporous membrane. The coating on one or both sides comprises, consists of, or consists essentially of a polymer that does at least one of the following: lowers the surface friction coefficient of the microporous membrane and lowers the shutdown onset temperature of the microporous membrane.

### A. Microporous Membrane

The microporous membrane is not so limited and may be any microporous membrane suitable for use in a battery separator. The microporous membrane may be any microporous membrane described herein. In some preferred embodiments, the microporous membrane is a microporous membrane made by a dry-stretch process such as the Celgard® dry stretch process.

### B. Coating

The coating described herein is not so limited. In some embodiments, the coating comprises, consists of, or consists essentially of a polymer that lowers the surface friction coefficient of the microporous membrane. This means that the coating has a lower surface friction coefficient than the microporous membrane without the coating. In some embodiments, the coating comprises, consists of, or consists essentially of a polymer that lowers the shutdown onset temperature of the microporous membrane. This means that the shutdown onset temperature of the coated microporous membrane is lower than that of the microporous membrane itself or without a coating. In some embodiments, the coating comprises, consists of, or consists essentially of at least one of polymer that lowers the surface friction coefficient of the microporous membrane, a polymer that lowers the shutdown onset temperature of the microporous membrane, or combinations thereof, and also an inorganic component. In some embodiments, no inorganic component is present. In some embodiments, a single polymer may both lower the surface friction coefficient of the microporous membrane and lower the shutdown onset temperature of the microporous membrane.

The inorganic component is not so limited and may be any inorganic component. In some embodiments, the inorganic component is one as described herein.

In some embodiments, the coating comprises a polymer that lowers the surface friction coefficient of the microporous membrane, and the battery separator has a pin removal force less than 350 N, less than 325 N, less than 300 N, less than 200 N, or less than 100 N. Low surface friction is important characteristic for a winding-type cell assembly process. The coating described herein significantly reduces film surface friction thus enhances pin-removal performance.

The pin removal properties are quantified using the following procedure that measures the ‘pin removal force (g).’ 1 g is 0.01 Newtons.

A battery winding machine was used to wind the separator (which comprises, consists of, or consists essentially of a microporous membrane with a coating layer applied on at least one surface thereof) around a pin (or core or mandrel). The pin is a two (2) piece cylindrical mandrel with a 0.16 inch diameter and a smooth exterior surface. Each piece has a semicircular cross section. The separator, discussed below, is taken up on the pin. The initial force (tangential) on the separator is 0.5 kgf and thereafter the separator is wound at a rate of ten (10) inches in twenty four (24) seconds. During winding, a tension roller engages the separator being wound on the mandrel. The tension roller comprises a 5%″ diameter roller located on the side opposite the separator feed, a ¾″ pneumatic cylinder to which 1 bar of air pressure is applied (when engaged), and a ¼″ rod interconnecting the roller and the cylinder.

The separator consists of two (2) 30 mm (width)×10″ pieces of the membrane being tested. Five (5) of these separators are tested, the results averaged, and the averaged value is reported. Each piece is spliced onto a separator feed roll on the winding machine with a 1″ overlap. From the free end of the separator, i.e., distal the spliced end, ink marks are made at ½″ and 7″. The ½″ mark is aligned with the far side of the pin (i.e., the side adjacent the tension roller), the separator is engaged between the pieces of the pin, and winding is begun with the tension roller engaged. When the 7″ mark is about ½″ from the jellyroll (separator wound on the pin), the separator is cut at that mark, and the free end of the separator is secured to the jellyroll with a piece of adhesive tape (1″ wide, ½″ overlap). The jellyroll (i.e., pin with separator wound thereon) is removed from the winding machine. An acceptable jellyroll has no wrinkles and no telescoping.

The jellyroll is placed in a tensile strength tester (i.e., Chatillon Model TCD 500-MS from Chatillon Inc., Greensboro, N.C.) with a load cell (50 lbs×0.02 lb; Chatillon DFGS 50). The strain rate is 2.5 inches per minute and data from the load cell is recorded at a rate of 100 points per second. The peak force is reported as the pin removal force.

COF (Coefficient of friction) Static is measured according to JIS P 8147 entitled “Method for Determining Coefficient of Friction of Paper and Board.”

In some embodiments, the polymer that does at least one of lowering the surface friction coefficient of the microporous membrane and lowering the shutdown onset temperature of the microporous membrane is siloxanes, silicone resins, fluororesins waxes (e.g., paraffin wax, microcrystalline wax, low-molecular weight polyethylene, and other hydrocarbon waxes), fatty acid esters (e.g., methyl stearate, stearyl stearate, monoglyceride stearate), aliphatic amides (e.g., stearamide, palmitamide, methylene bis stearamide), and combinations of any of the afore-mentioned. In some embodiments, the polymer that does at least one of lowering the surface friction coefficient of the microporous membrane and lowering the shutdown onset temperature of the microporous membrane is polyethylene. The form of the polyethylene is not so limited, and in some embodiments, polyethylene beads may be used.

In some embodiments, the coating comprises a polymer that lowers the shutdown onset temperature of the microporous membrane. In some embodiments, the polymer is a thermally responding polymer or one that melts at a given temperature less that the temperature at which the microporous membrane melts. In some embodiments, the shutdown onset temperature of the coated battery separator described herein is less than or equal to 160° C., less than or equal to 150° C., less than or equal to 140° C., less than or equal to 130° C., less than or equal to 120° C., less than or equal to 110° C., or less than or equal to 100° C. Thermally responding polymers can improve Shutdown performance, and allow tunable on-set temperature of shutdown for wider battery application

In some embodiments, the polymer that lowers the shutdown onset temperature of the microporous membrane is a polymer having a melting point in the range from 80° C. to 130° C., sometimes in the range of 90° C. to 120° C., sometimes in the range of 100° C. to 120° C., etc.

The polymer that lowers the shutdown temperature of the microporous membrane may be a particulate having an average particle size ranging from 0.1 to 5.0 microns, from 0.2 to 3.0 microns, from 0.3 to 1.0 microns, etc. These particles may be coated, uncoated, or partially coated.

In some preferred embodiments, the polymer that lowers the shutdown temperature of the microporous membrane may be particles comprising wax, oligomer, polyethylene (PE), for example low-density PE, and/or the like. These particles may be coated, uncoated, or partially coated. For example, they may be coated with latex and/or with a polymeric binder.

### IX. Coated Separator 4

Also disclosed herein is a battery separator comprising, consisting of, or consisting essentially of a coating on one or both sides of a microporous membrane. The coating on one or both sides comprises, consists of, or consists essentially of a cross-linked or cross-linkable polymer. In some embodiments, the coating on one or both sides comprises, consists of, or consists essentially of a cross-linked polymer. In some embodiments, the coating on one or both sides comprises, consists of, or consists essentially of a cross-linkable polymer. A cross-linkable polymer is a polymer that has not yet been cross-linked, but is capable of being cross-linked by light, heat, or any other means. A cross-linkable polymer comprises a cross-linker, which is a molecule that comprises at least two reactive ends to connect polymer chains. A cross-linked polymer is a polymer that has already been cross-linked. Due to the fact that no reaction will proceed to 100% completion, leaving no remaining reactants, a cross-linked polymer may comprise some residual unreacted cross-linker. In some embodiments, the cross-linked polymer comprises not more than 2%, not more than 1%, not more than 0.5%, not more than 0.1%, not more than 0.05%, not more than 0.01% or not more than 0.005% of the added cross-linker remaining after the cross-linking reaction to form the cross-linked polymer. The rest of the cross-linker will have reacted and formed a cross-link between at least two polymers. The initial amount of cross-linker in the composition (before curing or in the as-applied state), may be up to 100,000 ppm or 10%, up to 50,000 ppm or 5%, up to 10,000 ppm or 1% or up to 5,000 or 0.5% based on the total coating composition.

### A. Microporous Membrane

The microporous membrane is not so limited and may be any microporous membrane suitable for use in a battery separator. The microporous membrane may be any microporous membrane described herein. In some preferred embodiments, the microporous membrane is a microporous membrane made by a dry-stretch process such as the Celgard® dry stretch process.

### B. Coating

The coating described herein is not so limited. It may comprise, consist of, or consist essentially of a cross-linked or cross-linkable polymer. As explained above, both the cross-linked and cross-linkable polymers will comprise cross-linker. Cross-linkable is meant to described, for example, an as applied coating that contains cross-linkers, but has not been cross-linked yet. Cross-linking may proceed by any means including, but not limited to, light (e.g., UV light), heat, initiators, or combinations thereof.

Cross-linkers are molecules or monomers comprising at least two, or three, or four, or five, or more reactive groups that are capable of linking at least two polymer chains to one another. The cross-linkers is not so limited, and may be any molecule comprising two or more reactive groups that are capable of linking at least two polymer chains to one another. Some examples of cross-linkers include the following: di-functional acrylates, tri-functional acrylates including pentaerythritol triacrylate, multi-functional acrylates such as pentaerythritol tetraacrylate, ethyoxylated(4) pentaerythritol tetraacrylate, ditri,ethylolpropane tetraacrylate, dipentaerythritol pentaacrylate, dipentaerythritol hexaacrylate, and ethoxylated dipentaerythritol hexaacrylate, diepoxides including as 1,3 butane diepoxide, Bis[(4-glycidoxy)phenyl] methane and its isomers, 1,4 butanediol diglycidyl ether, 1,2,7,8 diepoxyoctane, diglycidyl 1,2-cyclohexanedicarboxylate, N,N-diglycidyl-4-glycidoxyaniline, triepoxides including tris(2,3-epoxypropyl)isocyanurate and tris (4-hydrocyphenyl) methane triglycidyl ether, dimethacrylates, trimethacrylates, and multifunctional methacrylates.

In some embodiments, the cross-linker may have a structure as shown in Formulae (1), (2), or (3) below:

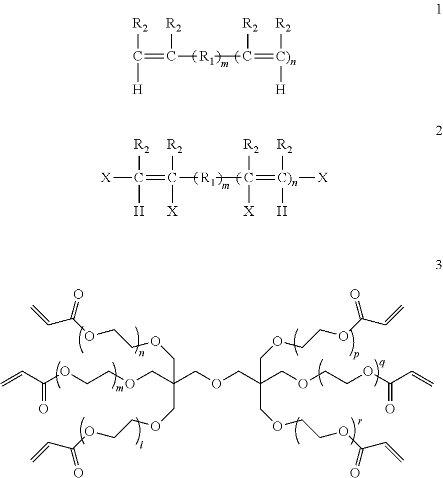

Where R₁ is alkyl or aryl containing any atom selected from C, O, N, S, F, or any mixture thereof, R₂ is H, alkyl or aryl containing any atom selected from C, O, N, S, F, or any mixture thereof, X is on or more containing R₁ and/or R₂, and l, m, n, o, p, q, and r is an integer between 1 and 20, 1 and 15, 1 and 10, or 1 and 5.

The coating may also comprise at least one polymer comprising reactive groups that are capable of reacting with the cross-linkers. For example, the polymer may comprise acrylate or methacrylate groups that may react with the diacrylate, triacrylate, multifunctional acrylate, dimethacrylate, trimethacrylate, and multi-functional methacrylate cross-linkers. In some embodiments, the polymer may comprise a nucleophilic group capable of reacting with the diepoxide or triepoxide cross-linking agents. The nucleophilic group may comprise, N, O, or S, in some embodiments.

When the cross-linker is added, in some embodiment, a catalyst can be added, which may initiate or catalyze cross-linking of, for example, two polymer chains, via the added cross-linker. The catalyst may be sensitive to heat, light, or chemical environment (e.g., pH), e.g., the catalyst may initiate or catalyze cross-linking of one or more polymer chains in the coating composition in response to heating, irradiation with light, or change in pH.

In some embodiments, the coating may comprise an inorganic component, and in some preferred embodiments, an inorganic component is not added to the coating. The inorganic component is not so limited and may be any inorganic component described herein.

In some embodiments, the coating may comprise an additional organic component, and in some preferred embodiments, an additional organic polymer component is added to the coating. The organic component is not so limited and may be any organic component described herein.

In embodiments where an inorganic component is not added, it is possible to form a very thin coating. In some embodiments, when an inorganic component is not added, the thickness of the coated microporous membrane is substantially the same as the thickness of the uncoated microporous membrane. In some embodiments, when an inorganic component is not added, the thickness of the coated membrane is not more than 500 nm, not more than 400 nm, not more than 300 nm, not more than 200 nm, not more than 100 nm, or not more than 50 nm thicker than the uncoated microporous membrane. This is possible, particularly in embodiments where an inorganic component is not added, because the coating may partially or fully enter into the pores of the microporous membrane. In embodiments where an inorganic component is added, the pores may be blocked or covered or partially blocked or covered by the inorganic component.

In some embodiments, a coated microporous membrane exhibits increased TD tensile strength compared to an uncoated microporous membrane. For example, the TD tensile strength of a coated microporous membrane may be as much as 160%, 150%, 140%, or 130% of that of the uncoated microporous membrane.

In some embodiments, a coated microporous membrane may have decreased standard deviation of TD elongation compared to an uncoated microporous membrane. For example, the standard deviation of TD elongation for a coated product is 50% or less, 60% or less, 70% or less, or 80% or less of that of an uncoated product.

In some embodiments, the MD shrinkage at 130° C. for 1 hr of a coated microporous membrane is 90% or less, or 80% or less, or 70% or less of that of an uncoated microporous membrane. Shrinkage may be measured by preparing a sample of the coated microporous membrane, measuring its' length in the MD direction before placing into the oven, placing the sample in the oven at 130° C. for one hour, and then measuring the length in the MD direction after being in the oven.

In some embodiments, the film thickness of the coated and uncoated product are substantially the same (or within the acceptable thickness variation of the film, such as, + or −0.5 micron). In some embodiments, the thickness of the coated product is less than 500 nm, less than 400 nm, less than 300 nm, less than 200 nm, less than 100 nm, or less than 50 nm thicker than the uncoated microporous membrane, i.e., the microporous membrane itself.

In some embodiments, the loading of the coated film is less than 120% or less than 110% of that for the uncoated microporous membrane or the microporous membrane itself.

In some embodiments, the Gurley of the coated film is increased compared to the uncoated microporous membrane. In some embodiments, the Gurley of the coated film is 130% or less, 120% or less, or 110% or less than that of the microporous membrane itself.

In some embodiments, the coated film exhibits extended shutdown compared to the microporous membrane itself.

In some embodiments, the coated film is less splitty than the microporous membrane itself. This may mean that when the film is punctured, the resulting opening is not a slit. In the case where the device used to puncture the film is round, the resulting opening will be round, not a slit.

### XI. Secondary Battery

A secondary battery comprising any battery separator described herein is described. The secondary battery is not limited. For example, the secondary battery may be a nickel-cadmium, nickel- metal-hydride, lithium-ion, sodium-ion, potassium-ion, or Nickel Zinc rechargeable batteries. In general, a secondary battery comprises, consists of, or consists essentially of electrodes, a separator, and an electrolyte.

In some embodiments, the battery cell may be a prismatic cell, a stacked cell, a cylindrical cell, a button cell, or a pouch cell. The different coated separators described herein may have advantages in one type of cell compared to another. For example, a dry adhesion may be beneficial in the formation of a stacked cell, but less beneficial in the formation of a cylindrical cell. This may be because, in a stacked cell, adhesion of the separator in the stack is important. It is important for the separator to stay in place when positioned on the electrodes so that underlying electrode is not exposed. In a cylindrical cell, dry adhesion may cause issues when the winding pin is removed.

### XII. Composite, Vehicle, or Device

A composite, jellyroll, pancake, or system is described herein comprising any separator as described hereinabove and one or more electrodes, e.g., an anode, a cathode, or an anode and a cathode, where the separator is provided in direct contact therewith. The specific type of electrode can be any electrode type not inconsistent with the objectives of this disclosure. For example, the electrodes can be those suitable for use in a lithium ion secondary battery.

A suitable anode can be any anode and can preferably have an energy capacity greater than or equal to preferably 372 mAh/g, preferably ≥700 mAh/g, and most preferably ≥1000 mAH/g. The anode can be constructed from a lithium metal foil or a lithium alloy foil (e.g. lithium aluminum alloys), or a mixture of a lithium metal and/or lithium alloy and materials such as carbon (e.g. coke, graphite), nickel, copper.

A suitable cathode can be any cathode compatible with the anode and can include an intercalation compound, an insertion compound, or an electrochemically active polymer. Suitable intercalation materials include, for example, MoS₂, FeS₂, MnO₂, TiS₂, NbSe₃, LiCoO₂, LiNiO₂, LiMn₂O₄, V₆O₁₃, V₂O₅, and CuCl₂. Suitable polymers include, for example, polyacetylene, polypyrrole, polyaniline, and polythiopene.

The electrolyte can be a liquid (organic or inorganic), a gel, or a polymer. Typically, the electrolyte primarily consists of a salt and a medium (e.g. in a liquid electrolyte, the medium can be referred to as a solvent; in a gel electrolyte, the medium can be a polymer matrix). The salt can be a lithium salt. The lithium salt can include, for example, LiPF₆, LiAsF₆, LiCF₃SO₃, LiN(CF₃SO₃)₃, LiBF₆, and LiClO₄, BETTE electrolyte (commercially available from 3M Corp. of Minneapolis, MN) and combinations thereof. Solvents can include, for example, ethylene carbonate (EC), propylene carbonate (PC), EC/PC, 2-MeTHF (2-methyltetrahydrofuran)/EC/PC, EC/DMC (dimethyl carbonate), EC/DME (dimethyl ethane), EC/DEC (diethyl carbonate), EC/EMC (ethylmethyl carbonate), EC/EMC/DMC/DEC, EC/EMC/DMC/DEC/PE, PC/DME, and DME/PC. Polymer matrices may include, for example, PVDF (polyvinylidene fluoride), PVDF:THF (PVDF:tetrahydrofuran), PVDF:CTFE (PVDF:chlorotrifluoro ethylene), PVDF:HFP (PVDF:hexafluoropropylene), PAN (polyacrylonitrile), and PEO (polyethylene oxide).

Any separator described hereinabove can be incorporated in any battery or cell, such as a lithium primary or secondary battery, lithium ion battery, lithium metal battery, or the like for any vehicle, e.g., an e-vehicle, or device, e.g., a cell phone or laptop, back-up or uninterruptible power supply (UPS), that is completely or partially battery powered.

### EXAMPLES

### Example 1

### First Layer Composition

Table 1 describes compositions and physical characteristics of exemplary first layers described in Section I.

TABLE 1
Exemplary First Layer Compositions

| Density | | | | | Layer density | Layer density |
|---|---|---|---|---|---|---|
| (g/cm3) | | | ratio | | (g/cm3) | (g/cm3) |
| alumina | acryl | 1-porosity | alumina | acryl | w/o porosity | w/porosity |

Acryl PCS (30% surface cover)

| | | | | | | |
|---|---|---|---|---|---|---|
| 0 | 1.2 | 0.15 | 0 | 1 | 1.20 | 0.18 |

Acryl PCS (100% surface cover)

| 0 | 1.2 | 0.5 | 0 | 1 | 1.20 | 0.60 |
|---|---|---|---|---|---|---|
| Density | | | | | Layer density | Layer density |
| (g/cm3) | | | ratio | | (g/cm3) | (g/cm3) |
| alumina | PvdF | 1-porosity | alumina | PvdF | w/o porosity | w/porosity |

PvdF PCS (30% surface cover)

| | | | | | | |
|---|---|---|---|---|---|---|
| 0 | 2 | 0.15 | 0 | 1 | 2.00 | 0.30 |

PvdF PCS (100% surface cover)

| | | | | | | |
|---|---|---|---|---|---|---|
| 0 | 2 | 0.5 | 0 | 1 | 2.00 | 1.00 |

### Example 2

### Second Layer Composition

Table 2 describes compositions and physical characteristics of exemplary second layers described in Section I.

TABLE 2
Exemplary Second Layer Compositions
Acryl/Alumina CCS

| Density | | | | | Layer density | Layer density |
|---|---|---|---|---|---|---|
| (g/cm3) | | | ratio | | (g/cm3) | (g/cm3) |
| alumina | acryl | 1-porosity | alumina | acryl | w/o porosity | w/porosity |
| 3.95 | 1.2 | 0.48 | 0.94 | 0.06 | 3.79 | 1.82 |

PvdF/Alumina MFS

| Density | | | | | Layer density | Layer density |
|---|---|---|---|---|---|---|
| (g/cm3) | | | ratio | | (g/cm3) | (g/cm3) |
| alumina | PvdF | 1-porosity | alumina | PvdF | w/o porosity | w/porosity |
| 3.95 | 2 | 0.48 | 0.75 | 0.25 | 3.46 | 1.66 |

Acryl/Boehmite CCS

| Density | | | | | Layer density | Layer density |
|---|---|---|---|---|---|---|
| (g/cm3) | | | ratio | | (g/cm3) | (g/cm3) |
| Boehmite | acryl | 1-porosity | alumina | acryl | w/o porosity | w/porosity |
| 3.04 | 1.2 | 0.58 | 0.94 | 0.06 | 2.93 | 1.70 |

PvdF/Boehmite MFS

| Density | | | | | Layer density | Layer density |
|---|---|---|---|---|---|---|
| (g/cm3) | | | ratio | | (g/cm3) | (g/cm3) |
| Boehmite | PvdF | 1-porosity | alumina | PvdF | w/o porosity | w/porosity |
| 3.04 | 2 | 0.58 | 0.75 | 0.25 | 2.78 | 1.61 |

### Example 3

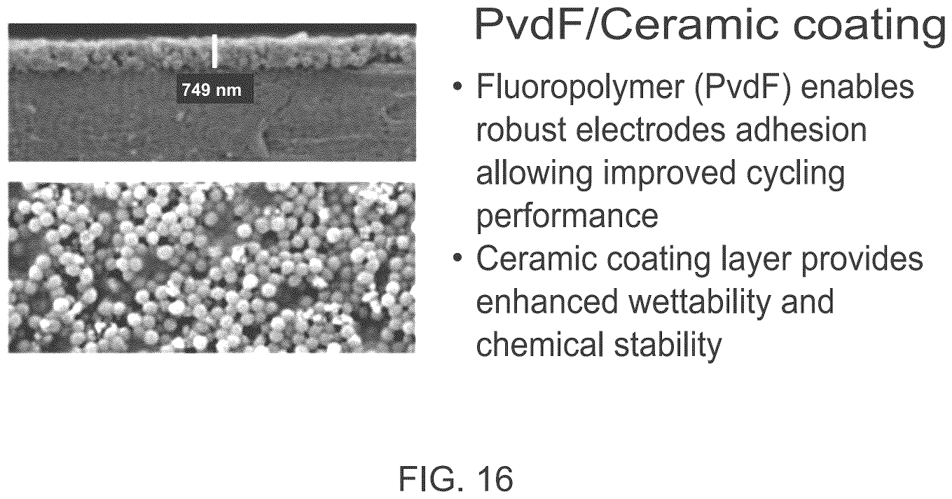

Herein, one example of a coated separator as described in section VII, “coated separator 2.” In this example, the coating comprises a ceramic component and PvdF (a wet sticky polymer). FIG. 15 shows a schematic drawing of this coating. FIG. 16 shows an SEM of this coating.

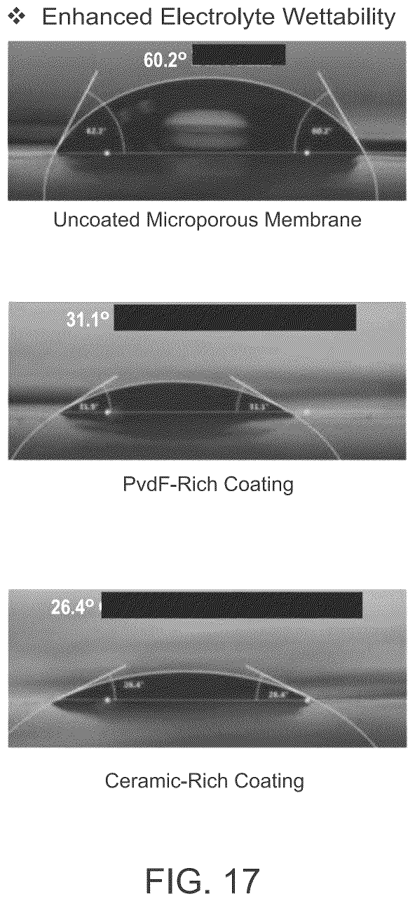

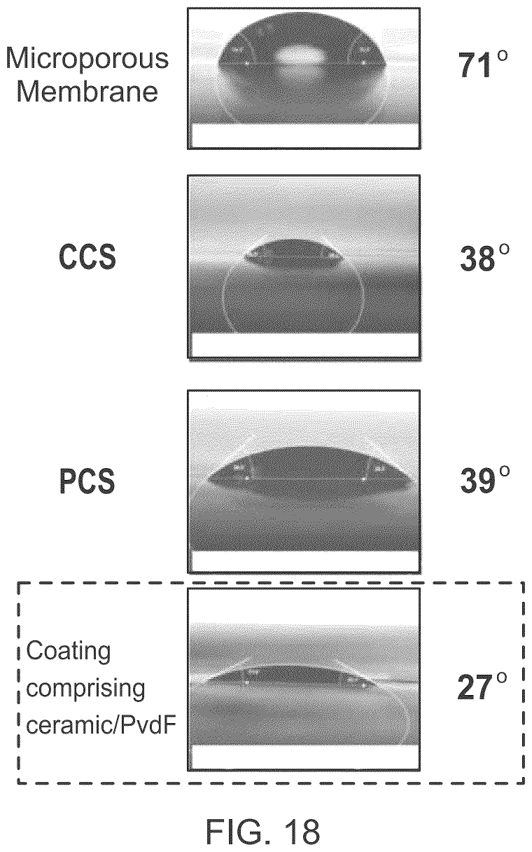

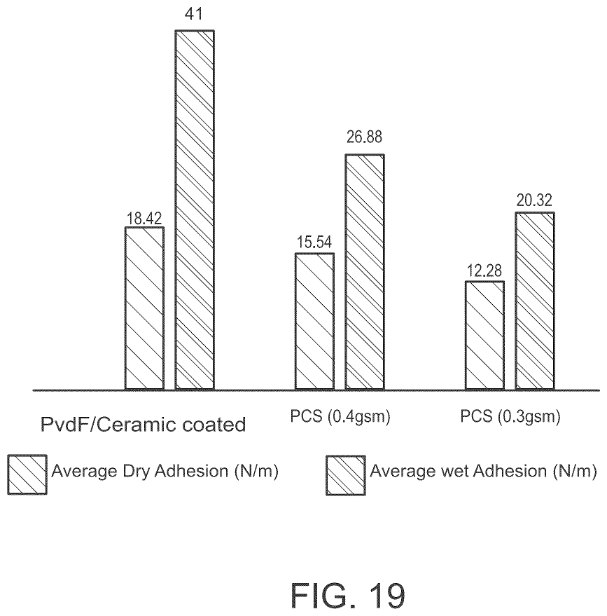

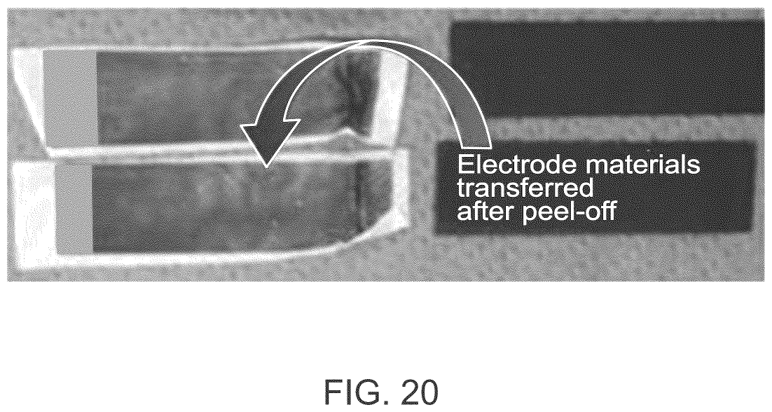

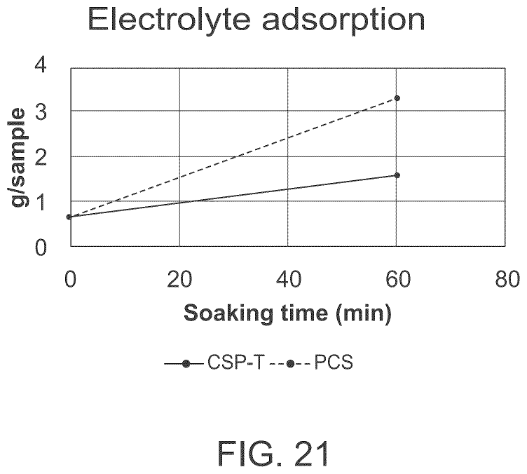

The amount of ceramic component in this coating was adjusted to form ceramic-rich and PvdF rich embodiments. The contact angle of these embodiments was measured and compared to an uncoated microporous membrane. The results showing this enhanced electrolyte wettability may be found in FIG. 17. Wettability of the coated separator described herein was also compared to uncoated microporous membrane (a different one than that used in FIG. 17), a known ceramic coated separator (CCS) without PvdF, and a polymer coated separator (PCS), without an inorganic component. These results are shown in FIG. 18. The coated separator described herein is found to be the most wettable with electrolyte. Average wet and dry adhesion of a coating described herein was compared with the average wet and dry adhesion of polymer coated separators with different loadings of polymer. The results are shown in FIGS. 19 and 20. FIG. 20 shows electrode adhesion to the coating after the test for adhesion has been conducted. The electrolyte absorption of a coated separator as described herein was measured and compared to a polymer coated separator. The results are shown in FIG. 21.

### Example 4

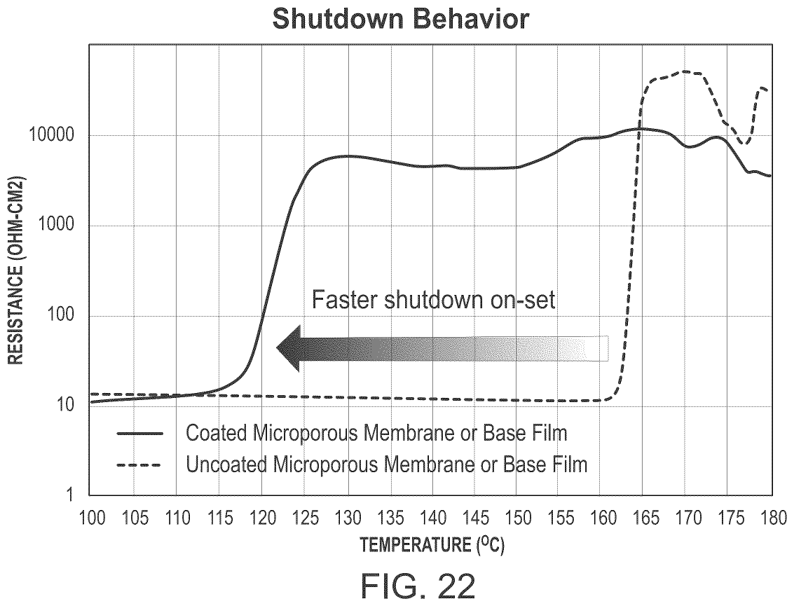

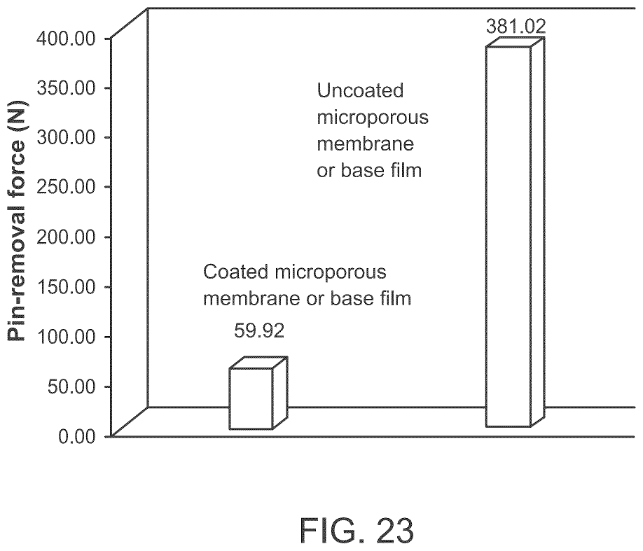

In this Example, one example of a coated separator as described in section VIII (“coated separator 3”) was prepared. Shutdown of the coated separator was measured and compared to that of the microporous membrane or base film itself. The results of this rest are shown in FIG. 22. Pin removal force of the coated separator described herein compared to the uncoated microporous membrane or base film was measured and the results are shown in FIG. 23.

### Example 5

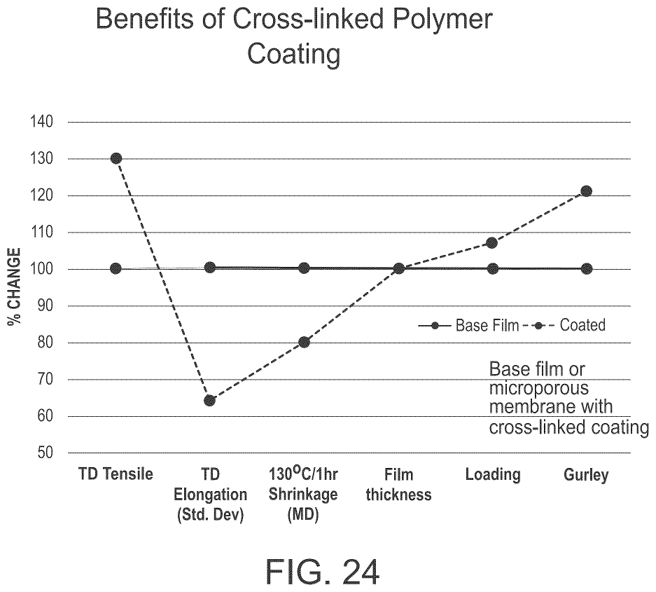

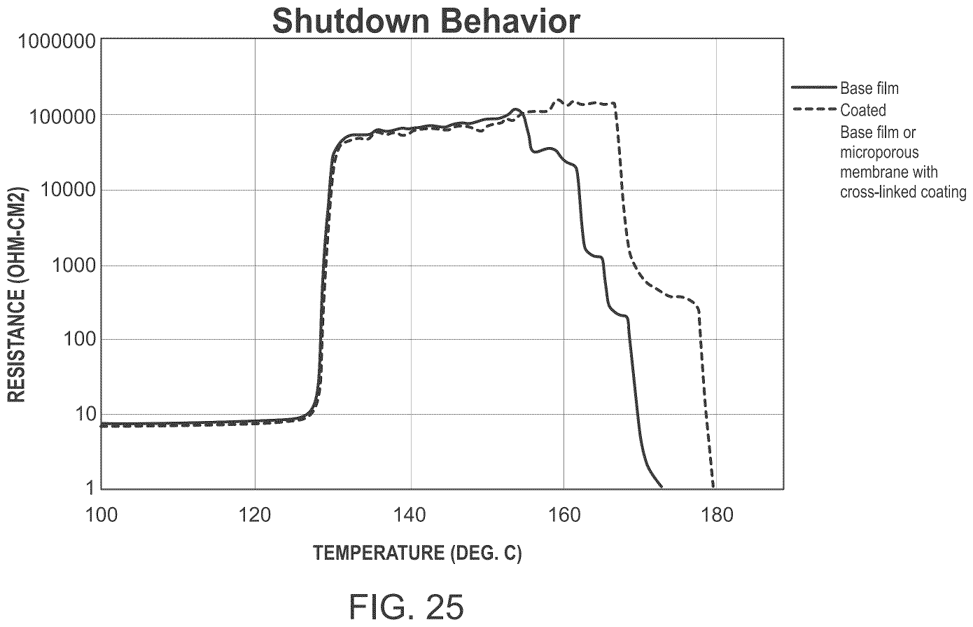

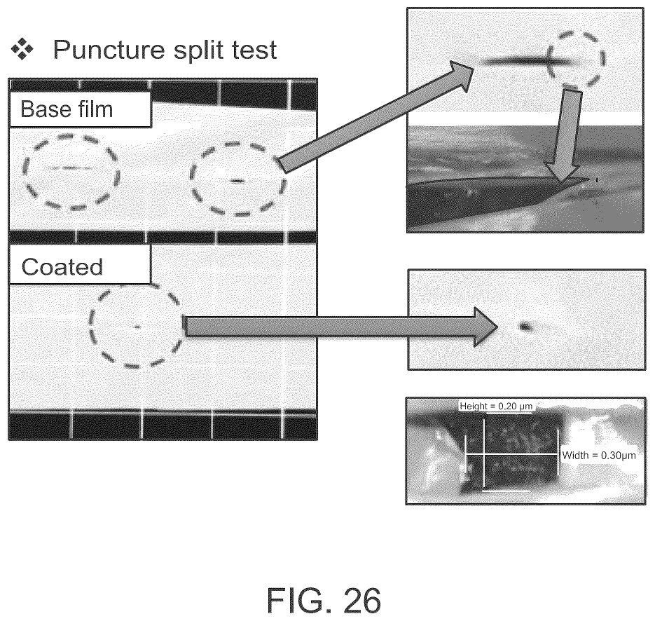

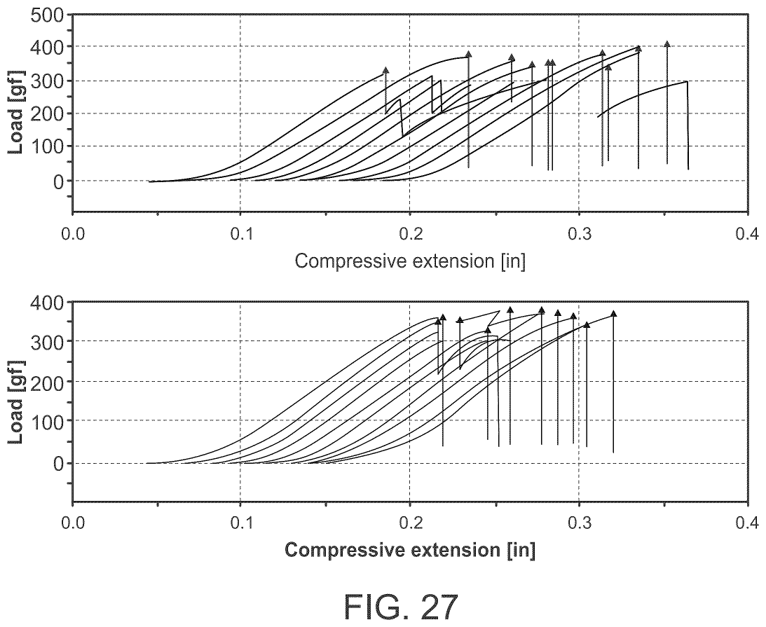

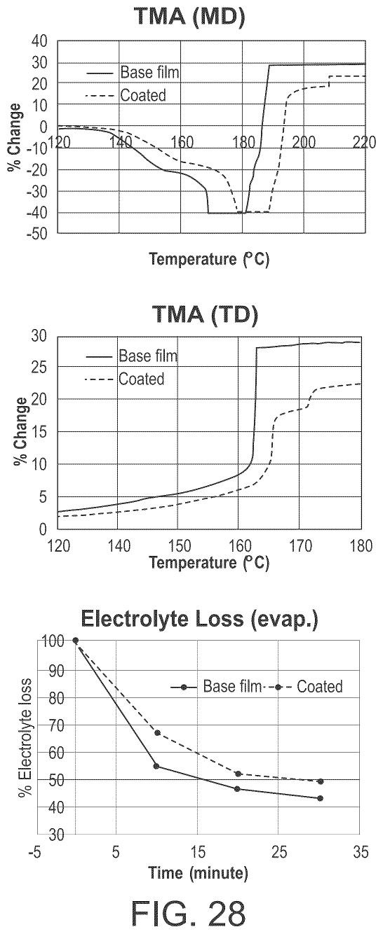

In this Example, one example of a coated separator having a microporous membrane and a cross-linked coating as described in section IX (“coated separator 4”) was prepared. The separator coating did not contain any inorganic component. Properties of the separator, including TD tensile, TD elongation, MD shrinkage at 130° C. for 1 hour, film thickness, loading, and Gurley were tested. FIG. 24 compares these results to those for the uncoated microporous membrane. Shutdown behavior of the coated separator was also studied and compared to that of the uncoated microporous membrane. These results are in FIG. 25. A puncture test was conducted on the coated separator and compared to results for the uncoated microporous membrane. These results are shown in FIG. 26. Compression extension was evaluated, and these results are presented in FIG. 27. Finally, TMA(MD), TMA(TD), and electrolyte loss were measured, and these results are presented in FIG. 28, which compares coated vs. uncoated microporous membrane. The electrolyte loss test involves exposing the wet film to air, thus inducing ambient evaporation of carbonate electrolyte. Carbonate electrolyte is organic solvent like acetone, thus fairly fast evaporation is expected. The inventive coated sample is slower in losing electrolyte, meaning that the coating material keeps the electrolyte longer, thus a reduced electrolyte loss.

Disclosed herein are battery separators that include a microporous membrane and a coating. The coating may comprise, consist, or consist essentially of polymeric components, inorganic components, or combinations thereof. The battery separators described herein are, among other things, thinner, stronger, and more wettable with electrolyte than some prior battery separators. The battery separators may be used in secondary or rechargeable batteries, including lithium ion batteries. The batteries may be used in vehicles or devices such as cell phones, tablets, laptops, and e-vehicles.

In a battery, capacitor, vehicle, device, textile, garment, filter, medical device, or transdermal patch, the improvement comprising a coated microporous membrane.

A new or improved coated microporous membrane, porous substrate, base film, and/or thin film, coating, thin coating, ultra-thin coating, and/or nano-thin coating, battery separator, capacitor separator, textile, filter, layer, component, and/or the like, battery, capacitor, vehicle, device, textile, garment, filter, medical device, and/or transdermal patch, and/or the like as described, shown, or claimed herein.

Various embodiments of the present invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A battery separator comprising a coating on one or both sides of a microporous membrane, the coating on at least one side comprising:
between 10 and 80% of an inorganic component;
a wet adhesion polymer and a dry adhesion polymer; and
wherein electrolyte wettability of the coating is a <35 o contact angle and wherein the contact angle is measured by measuring an angle between an end of drop of an electrolyte on the coating and the coating.

2. The battery separator of claim 1, wherein the wet adhesion polymer is a fluoropolymer.

3. The battery separator of claim 1, wherein the coating comprises a dry adhesion polymer.

4. The battery separator of claim 3, wherein the dry adhesion polymer has a glass transition temperature less than 100 oC or less than 70 oC.

5. The battery separator of claim 1, wherein the coating comprises an inorganic component, a wet adhesion polymer, and a dry adhesion polymer.

6. The battery separator of claim 1, wherein the coating has a thickness of 1 micron or less.

7. The battery separator of claim 5, wherein at least one of the inorganic component, the wet adhesion polymer, and the dry adhesion polymer have an average particle size of 500 nm or less.

8. The battery separator of claim 1, wherein the coating has a wet adhesion >30 N/m.

9. The battery separator of claim 8, wherein the coating has a dry adhesion of >16 N/m.

10. The battery separator of claim 1, wherein the coating has an electrolyte absorption of ≥2 g/sample after 60 min.

11. A lithium ion battery comprising the battery separator of claim 1, wherein the lithium ion battery is a cylindrical type, prismatic type, or pouch type battery.

12. A vehicle or device comprising the lithium ion battery of claim 11.

13. The battery separator of claim 1, wherein the coating is on both sides of a microporous membrane, wherein the coating comprises a polymer that does at least one of the following: lowers the surface friction coefficient of the microporous membrane and lowers the shutdown onset temperature of the microporous membrane.

14. The battery separator of claim 13, wherein the coating comprises a polymer that lowers the surface friction coefficient of the microporous membrane and the battery separator has a pin removal force of less than 350 N.

15. The battery separator of claims 13, wherein the coating comprises a polymer that lowers the shutdown onset temperature of the microporous membrane and the battery separator has a shutdown onset temperature of ≤160 oC.
